(19) United States
(12) Patent Application Publication
(10) Pub. No.: US 2025/0286374 A1
(43) Pub. Date: Sep. 11, 2025

(54) GENERATING ELECTRICAL ENERGY USAGE GUIDANCE

(71) Applicant: Apple Inc., Cupertino, CA (US)

(72) Inventors: Ian Falcon, Solana Beach, CA (US); Brian J. Tucker, San Jose, CA (US); Nicholas A. Russo, Rancho Mission Viejo, CA (US); Joelle L. Lam, Los Altos Hills, CA (US); Lauren Hannah, Kensington, CA (US); Elizabeth A. Watson, Silver Spring, CA (US); Andrea R. Romano, San Francisco, CA (US); Kristina B. Stanford, San Francisco, CA (US)

(73) Assignee: Apple Inc., Cupertino, CA (US)

(21) Appl. No.: 19/077,006

(22) Filed: Mar. 11, 2025

Related U.S. Application Data
(60) Provisional application No. 63/563,764, filed on Mar. 11, 2024.

(51) Int. Cl. H02J 3/00; H02J 13/00

(52) U.S. Cl. CPC H02J 3/003; H02J 13/00001

(57) ABSTRACT

Techniques are described for providing forecasted electrical energy usage guidance to consumers of electrical energy supplied by a power grid in a given region. The forecasted electrical energy usage guidance is designed to encourage the consumption of electrical energy generated by renewable energy sources and to discourage the consumption of electrical energy generated by nonrenewable energy sources. The techniques can utilize historical and forecasted electrical energy generation data and historical and forecasted electrical energy demand data for the power grid to generate the energy usage guidance. In some examples, historical marginal operating emissions rate data, renewable electrical energy generation curtailment data, demand data, grid alert data, and location marginal pricing data may also be used.

### CROSS-REFERENCES TO RELATED APPLICATIONS

This application claims priority under 35 U.S.C. § 119 (e) to U.S. Provisional Application Ser. No. 63/563,764, filed Mar. 11, 2024, entitled “GENERATING ENERGY WINDOWS,” which is incorporated herein by reference in its entirety.

### BACKGROUND

Electrical energy supplied to users by providers can be generated using both nonrenewable (e.g., fossil fuel burning) and renewable (e.g., wind, solar) generation techniques. Both renewably generated electrical energy and non-renewably generated electrical energy can be distributed to users via transmission and distribution lines of a power grid. For various reasons, peak user electrical energy consumption may not currently align with the most opportune time to generate renewable electrical energy, which can undesirably result in meeting user demand through over-reliance on polluting nonrenewable electrical energy sources and under-reliance on clean nonrenewable electrical energy sources.

### BRIEF DESCRIPTION OF THE DRAWINGS

FIG. 1 is a block diagram illustrating a system for implementing an energy usage information service according to one or more embodiments.

FIG. 2 is a block diagram illustrating intended results of employing systems and techniques of the present disclosure according to one or more embodiments.

FIG. 3 is a block diagram illustrating a process for creating a historical energy (target) signal by identifying, classifying, and prioritizing events present in historical data associated with the operations of a power grid according to one or more embodiments.

FIG. 4 is a block diagram illustrating a process for creating a forecasted energy signal by identifying, classifying, and prioritizing events present in forecasted data associated with the operations of a power grid according to one or more embodiments.

FIG. 5 is a block diagram further illustrating a process for creating a historical energy (target) signal by identifying, classifying, and prioritizing events present in historical data associated with the operations of a power grid according to one or more embodiments.

FIG. 6 depicts a process flow for generating a historical energy (target) signal using a computing system according to one or more embodiments.

FIG. 7 depicts a process flow for generating a forecasted energy signal using a computing system according to one or more embodiments.

FIG. 8 depicts a process flow for generating net peak demand thresholds using a computing system according to one or more embodiments.

FIG. 9 is a flow diagram depicting one example of a machine learning model training methodology according to one or more embodiments.

FIG. 10A is a schematic diagram illustrating an environment in which a computing system can generate forecasted electrical energy usage guidance and provide the guidance to user devices according to one or more embodiments.

FIG. 10B is a schematic diagram illustrating an environment in which a computing system can generate historical electrical energy usage information and provide the information to user devices according to one or more embodiments.

FIG. 11 is a schematic diagram illustrating an environment in which a computing system can generate multiple instances of forecasted electrical energy usage guidance and transmit the guidance to an entity for the benefit of customers or other users associated with the entity according to one or more embodiments.

FIG. 12 is a schematic diagram illustrating an example architecture or environment configured to implement techniques related to generating electrical energy usage guidance and shaping the load on a power grid according to one or more embodiments.

FIG. 13 is a process flow for a method of generating electrical energy usage guidance and shaping the load on a power grid according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Energy providers (e.g., utilities) can generate electrical energy using traditional nonrenewable energy sources and/or renewable energy sources. Renewable energy sources can be integrated into the power grid along with the nonrenewable energy sources such that electrical energy from both energy source types can be distributed to consumers (e.g., home, business, etc.) via transmission and distribution lines of the power grid. Nonrenewable energy sources can be, for example, centralized power plants that generate electrical energy by burning coal or natural gas. Renewable energy sources may be solar powered or wind powered sources in some embodiments. In some cases, renewable energy sources may be implemented as distributed generation sources—i.e., small-scale renewable energy sources such as, for example, rooftop solar panels or local community solar arrays. In other cases, renewable energy sources may be implemented as centralized utility-scale energy sources—i.e., large scale renewable energy sources such as, for example, large commercial wind farms and/or large commercial solar panel arrays.

Ideally, electrical energy generation and consumer demand for electrical energy are equal at any given time, although this may often be not the case. In most regions of the United States, the supply of electrical energy from renewable energy sources is not sufficient by itself to meet demand, or not enough electrical energy generated by renewable energy sources can be stored for use at times when renewable energy sources cannot produce electrical energy (e.g., at night in the case of solar power sources). Furthermore, traditional nonrenewable electrical energy generation sources, which typically generate electrical energy by rotating turbine generators using steam produced by burning fossil fuels, are designed to be most efficient when operating at maximum capacity. Thus, operation of traditional nonrenewable electrical energy generation sources at reduced capacity can be undesirable. These factors have largely resulted in continued heavy reliance on traditional nonrenewable electrical energy generation sources, either as the only or the primary mechanism for meeting consumer demand, or for significant supplementation of renewable energy source capacity.

Currently, the total consumer demand for electrical energy exceeds the amount of electrical energy produced through renewable energy resources alone-meaning all of the electrical energy produced by existing renewable energy sources could be consumed. However, because times of high electrical energy demand may not always coincide with peak or optimal times of electrical energy generation by renewable energy sources, this is not the case. In actuality, electrical energy by renewable energy sources may sometimes be deliberately curtailed because production capacity exceeds current demand and there is an inability to store the excess electrical energy if the renewable energy sources continued to run at full capacity. This can encourage electrical energy providers to continue using nonrenewable energy sources, and can discourage electrical energy providers from using renewable energy sources and/or disincentivize electrical energy providers from building additional renewable energy sources.

Unfortunately, while renewable energy sources are environmentally friendly, non.-renewable energy sources typically are not. For example, non-renewable energy sources can contribute to carbon dioxide emissions and other greenhouse gases. Different nonrenewable energy sources can contribute various levels of polluting emissions to the atmosphere. Electrical energy generation through the combustion of coal may result in the highest carbon dioxide emissions of the nonrenewable energy sources, and may also result in the emission of sulfur dioxide, nitrogen dioxide, and particulates. Burning oil can result in less carbon dioxide emissions than burning coal, but can still contribute to greenhouse gases in the atmosphere. The combustion of natural gas produces less carbon dioxide, sulfur dioxide, and nitrogen oxide than coal or oil, but is nonetheless polluting n comparison to clean renewable energy sources and can still emit heat into the atmosphere.

Consumers may be generally unaware whether the electrical energy they consume is being generated through renewable energy sources or nonrenewable energy sources. If consumers were aware of the source, or that the source may change over the course of a day or another time period, consumers might modify their behavior so as to use electrical energy at times when it is likely (or more likely) that the electrical energy is generated by a more environmentally friendly renewable energy source(s).

Embodiments herein address the above-referenced issues by providing computerized systems and methods via which electrical energy generation information can be received or retrieved and used to provide at least forecasted electrical energy usage guidance to consumers. The forecasted electrical energy usage guidance is designed to encourage the consumption of electrical energy generated by renewable energy sources, to discourage the consumption of electrical energy generated by nonrenewable energy sources, and to generally shape the load on a given power grid around renewable energy sources rather than nonrenewable energy sources.

In various embodiments, a computer system (e.g., of a service) may receive or retrieve historical data related to electrical energy generation and electrical energy demand from various sources associated with a given distribution region to generate the energy usage guidance. For example, the service may receive or retrieve historical data comprising historical marginal operating emissions rate (MOER) data, renewable electrical energy generation curtailment data, renewable electrical energy generation data, demand data, grid alert data, and location marginal pricing (LMP) data. In other embodiments, a forecasted version of at least some of this data may be received or retrieved. In any case, the data may serve as input signals that the service can use to generate electrical energy usage information (e.g., guidance and/or reports) for consumers.

Examples of the MOER data can include historical data indicating whether nonrenewable energy sources previously reacted to or are predicted to react to a change in load (demand) and if so, what the emissions rate was when reacting to the past change in demand or is likely to be when reacting to a future change in demand. Examples of the renewable electrical energy generation curtailment data (“renewable energy curtailment data”) can include historical data regarding an amount (e.g., in megawatts) by which available electrical energy from a given renewable energy source was or is predicted to be curtailed at a given time or over a given time interval. Examples of the renewable electrical energy generation data (“renewable energy generation data”) can include historical solar energy generation data, wind energy generation data, or the like, for a given time period. Examples of the net demand data can include historical gross electrical energy demand data for a given time period, and the net demand may be determined by subtracting from the gross electrical energy demand, the amount of renewable electrical energy generation available for the same time period. Examples of the grid alert data can include historical data regarding the current usage status of a given power grid. For example, the grid alert data could indicate times when the grid has been or is forecast to be under high strain. The grid alert data may include Flex Alert or Energy Emergency Alert data in some examples. Examples of the LMP data can include the wholesale price charged for generated electrical energy by a given provider at a given time. The use of LMP allows wholesale electric energy prices to reflect the value of electric energy at different locations, accounting for the patterns of load, generation, and physical limits of the associated transmission system.

There is no single source of ground truth in the received/retrieved data because use of the data according to one or more embodiments may be associated with a custom mix of goals. Consequently, a ground truth may be synthesized as a target signal. To this end, the historical data inputs may be used to generate historical energy (target) signal. For example, events within the historical data may be identified, then classified, and prioritized using a set of goals and rules. The events may reflect one or more historical conditions of the power grid. The highest priority event may then be output as an expected value. The highest priority event may represent a most opportune past time during which to use renewable electrical energy supplied through a power grid. The highest priority event may change depending on the goals and rules applied to the classification and prioritization operations. With an example target signal defined, a forecasted signal that forecasts the target signal can be generated. The forecasted signal may be created in a similar manner to the target signal, at least in the sense that events in the input data may be identified, then classified and prioritized using the set of goals and rules. The forecasted events may reflect one or more forecasted (predicted future) conditions of the power grid. In the case of the forecasted signal, however, the input data can be forecasted data and/or historical data. As discussed in more detail below, forecasting of the target signal may be performed, at least in part, using a machine learning model.

To generate the energy usage guidance, the computing system (service) can use one or more machine learning (ML) models to predict what events are likely to occur within some future and predetermined time period (e.g., the following day or the next week). When it is predicted that a given event is likely to occur, the event can be classified and subsequently prioritized, at least in part, by the ML model in view of the predefined goals and rules. The goals and rules used by the service to prioritize predicted events may be changed. Generally speaking, however, the forecasted signal and a ML model can be implemented in a manner that prioritizes events that will encourage a user to consume electrical energy generated by a renewable energy source, such as during a predicted curtailment of a renewable energy source, a predicted period of optimal renewable electrical energy generation, or during a time where the likelihood that consuming electrical energy generated by a renewable energy source(s) will result in a low MOER and not a high MOER. In one example, where the service predicts each of a curtailment of a renewable energy source, a predicted period of optimal renewable electrical energy generation, or the likelihood that consuming electrical energy generated by a renewable energy source(s) will result in only a low MOER, the rules may cause the service to select curtailing of the renewable energy source as a highest priority event. Consequently, the corresponding energy usage guidance generated by the service can recommend that the recipient user consumes electrical energy within one or more particular time windows of one or more future dates on which renewable energy source curtailment may be predicted. In this manner, the service may affect the electrical energy usage behavior of enough consumers to encourage the associated electrical energy provider to rely more heavily on renewable energy and less on nonrenewable energy, and perhaps to encourage the electrical energy provider to replace more of their nonrenewable energy sources with renewable energy sources. For example, if the load on a power grid increases during periods when the contribution of renewable energy sources to the total amount of electrical energy supplied to power grid is high, an electrical energy provider may be incentivized to demand that renewable energy producers generate more electrical energy using cleaner energy sources.

In another example, the service can use historical data along with other information such as consumer time-of-use (TOU) rate data to generate electrical energy usage reports that inform consumers how their prior (e.g., previous day) energy consumption was allocated between renewable and nonrenewable energy sources. An electrical energy usage report may also advise the consumer as to whether their usage was good or bad from a rate standpoint. The reports may be instructional at least in the sense that the reports may help the consumers identify consumption that was fulfilled using electrical energy generated by nonrenewable energy sources but could have been fulfilled using electrical energy generated by renewable energy sources, and also that there may be times of the day when electrical energy can be consumed at a lower cost.

Electrical energy usage guidance and reports may be provided to consumers or other users by, for example, transmitting the guidance or reports directly or indirectly to user devices such as smart phones, smart watches, tablets, home automation (e.g., smart home) equipment, etc. In some examples, the reports or guidance may be transmitted as messages of some format. In other examples, the reports or guidance may be transmitted as notifications, including push notifications using for example, the Apple Push Notification service (APNs). In other examples, the user computing devices may include one or more applications related to energy management or similar services and the guidance or report information may be received in another format that is readable and usable by the one or more applications, and displayable under the control of the application(s). In some examples, in-app notifications may be supported and may appear as an in-line popup on a user interface of a user computing device.

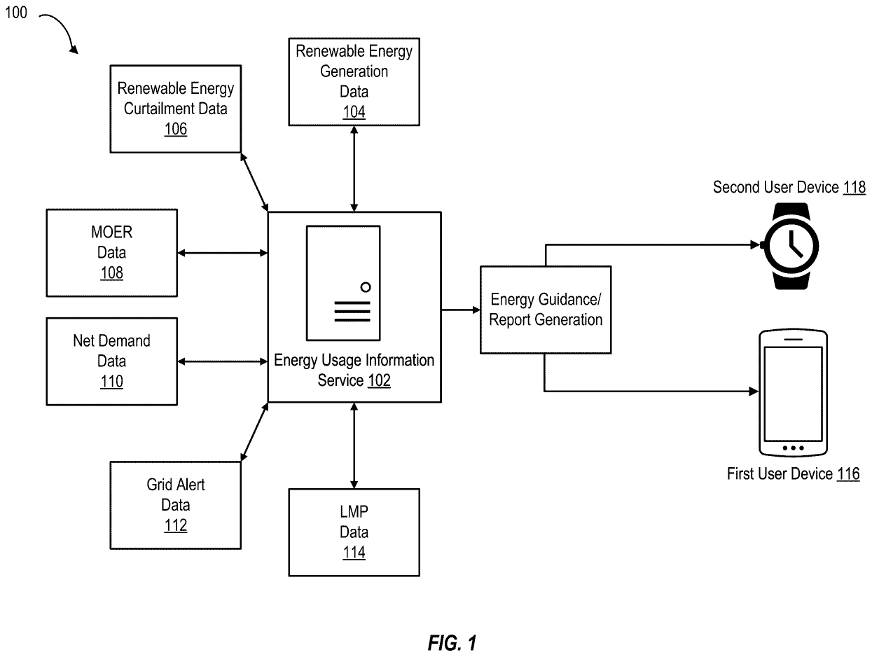

FIG. 1 is a block diagram illustrating a system for implementing an energy usage information service 102 according to one or more embodiments. An energy usage information service 102 can receive various types of data from multiple sources and can use the data to generate energy usage guidance or an energy usage report that may be provided to customers of a given power grid or others. For example, in this embodiment the energy usage information service 102 can retrieve or receive renewable generation data 104, renewable energy curtailment data 106, marginal operating emissions rate (MOER) data 108, net demand data 110, grid alert data 112, and location marginal pricing (LMP) data 114. The data 104-114 can be received or retrieved from, for example, various renewable energy and nonrenewable energy providers including large utilities and independent system operators (ISOs), regional transmission organizations (RTOs), environmental non-profit organizations (e.g., WattTime), and government sources such as the U.S. Energy Information Association (EIA).

A renewable energy provider (source) can include, for example, a utility that operates one or more renewable energy facilities such as solar power plants and/or wind power plants. A solar power plant can generate electrical energy using a plurality of solar panels, each of which includes photovoltaic cells that can absorb photons from sunlight and use the photons to generate electrical energy by way of a photovoltaic process. Solar energy can be considered a renewable energy source based on its use of sunlight to generate electrical energy and because neither the solar panels nor the solar power plant emit carbon dioxide or other greenhouse gases in the process of generating electrical energy. A wind power plant can generate electrical energy using one or more land-based or sea/lake-based wind turbines each having an electric generator that is rotated by wind-driven turbine blades. Similar to solar energy, wind energy can be considered a renewable energy based on its use of wind and because neither the turbine generators nor the wind power plant emit carbon dioxide or other greenhouse gases in the process of generating electrical energy. A nonrenewable energy provider on the other hand, can include a utility that operates one or more facilities that are powered by nonrenewable energy sources, such as fossil fuel power plants. Fossil fuel power plants generate electrical energy through the combustion of a fossil fuel such as, for example, coal, natural gas, or oil. Typically, the heat of combustion is used to produce steam, which can then be used to drive turbine generators. The type and amount of emissions generated during operation of such a nonrenewable energy source may be based on the fuel that is burned and the efficiency of combustion and operation. In any case, a typical nonrenewable energy source such as a fossil fuel power plant will emit various greenhouse gases and heat into the atmosphere.

It should be appreciated that in some cases, various other types of electrical energy generation sources such as, but not limited to, hydroelectric, nuclear, geothermal, and tidal energy sources may also contribute electrical energy to a power grid for distribution to consumers. In some cases, a utility may operate both a renewable energy source(s) and a nonrenewable energy source(s).

The energy usage information service 102 can receive or retrieve the renewable generation data 104 from some or all of the renewable energy sources present in a given region for which the energy usage information service 102 intends to generate electrical energy usage guidance or reports. The renewable generation data 104 may generally include information regarding renewable energy production. For example, the renewable generation data 104 can include historical solar power energy generation data and historical wind power energy generation data or the like.

The energy usage information service 102 can also receive the renewable energy curtailment data 106 from the multiple data sources. As previously discussed, electrical energy generation by renewable energy sources may sometimes be deliberately curtailed because the generating capacity of the renewable energy sources exceeds a current demand for electrical energy and there is an inability to store the excess electrical energy that will be generated if the renewable energy sources continue to run at full capacity. Additionally, renewable energy is dependent on a generation source (e.g., wind or sunlight) that can be unpredictable and over which the electrical energy providers have no real control. In some instances, a solar energy plant or a wind energy plant operator may elect to curtail plant output for reasons including but not limited to the state of the generation source (e.g., a lack of sufficient sun or a lack of sufficient wind). In other instances, renewable energy source curtailment may be requested by a power grid operator who purchases electrical energy from an operator of a solar energy plant or a wind energy plant. Thus, the renewable energy curtailment data 106 can, in some examples, include historical and/or forecasted data regarding an amount by which available electrical energy from a given renewable energy source (or all renewable energy sources in a given region) was or is predicted to be curtailed at a given time or over a given time interval. For example, the renewable energy curtailment data 106 may indicate by how much (e.g., in megawatts) an output of a given renewable energy source was already curtailed in a past time period (e.g., the previous day) and/or by how much the output of the given renewable energy source is predicted to be curtailed during a future time period (e.g., a next day).

The energy usage information service 102 can also receive or retrieve the MOER data 108 from the multiple data sources. The MOER data 108 is associated with marginal electrical energy generation by an energy source. Marginal generation can refer to selecting (e.g., by a power grid operator) a source of additional electrical energy generation to meet an incremental demand at a given point in time. In other words, marginal generation is the selection of the next power source to be used to meet an incremental increase in demand. The MOER can depend on whether the operator selects a renewable energy source or a nonrenewable energy source to meet the increase in demand, or if a nonrenewable energy source is selected, a type of fuel burned by the nonrenewable energy source. A power grid operator can select the next electrical energy generation source based on various factors such as, for example, which provider has the lowest costs associated with generating the electrical energy.

The MOER is indicative of the amount of greenhouse gas emissions produced by an electrical energy source in generating an additional unit of electrical energy (e.g., in kilograms or grams of CO₂ per kilowatt-hour of energy generated). Thus, the MOER can quantify the environmental impact of increasing electrical energy generation to meet changing demand or for other reasons. The MOER can vary depending on the energy source(s) used to generate the additional unit of electrical energy. For instance, if a marginal increase in electrical energy generation results from burning additional coal, oil, or natural gas in a fossil fuel power plant versus temporarily increasing the output of a renewable source like solar or wind, the MOER will be higher because of the resulting CO₂ emissions of the fossil fuel power plant. Likewise, the MOER value can vary among different types of nonrenewable energy sources (fossil fuel power plants) because, for example, the combustion of coal, oil, and natural gas does not produce the same amounts of CO₂ emissions.

The MOER can also be influenced by the region in which the power grid and/or an energy source(s) is located, and for which the energy usage information service 102 will be used to generate electrical energy usage reports and guidance to users. For example, if the data sources and the users are located in a region that relies on a mix of power that heavily favors coal or other fossil fuels, the MOER may be higher than it would be if the data sources and the users were located in a region that relies on a more balanced mix of nonrenewable energy and renewable energy. The MOER can also fluctuate throughout the day. For example, during midday, as more electrical energy from solar power plants is added to the power grid, the MOER may decrease due to the availability of the additional renewable electrical energy. As such, the energy usage information service 102 can, in some embodiments, continuously or very frequently receive information regarding the MOER for each new unit of electrical energy that is generated.

The MOER data 108 received or retrieved from the one or more data sources can include historical and/or forecasted data identifying if higher emitting electrical energy sources previously reacted to or are predicted to react to an incremental change in demand and if so, what the emissions rate was when reacting to the past incremental change in demand or what the emissions rate is likely to be when reacting to a future incremental change in demand.

The energy usage information service 102 can also receive or retrieve from the multiple data sources, the net demand data 110 or the data needed to generate the net demand data 110. Net demand refers to the total (gross) electrical energy demand that needs to be met through the power grid after accounting for the contribution of renewable energy sources and nuclear power. In other words, net demand represents the demand for electrical energy that is required to be met by dispatchable or controllable power plants, such as natural gas, coal, and other fossil fuel-based power plants, or any other sources that can be turned on or off or adjusted to match demand. Renewable energy sources are not relied upon (are subtracted) when determining net demand due to the variability of their operation. For example, the output of wind and solar power energy sources can depend on weather conditions, time of day, and season, which can create variability in the power grid. Consequently, a frequent determination of net demand may be necessary to ensuring that enough flexible electrical energy generation is available to fill any gaps resulting from the variability of renewable energy sources. Other techniques for managing net demand may also be employed. For example, customers, especially large industrial customers, may be encouraged or incentivized to use less electrical energy during times of peak demand, thereby reducing the need for additional generation. Excess electrical energy generated by renewable energy sources during periods of low demand may also be stored using battery or capacitor systems or pumped hydro storage to further help reduce dependence on nonrenewable energy sources and to manage net demand.

In some examples, the net demand data 110 received or retrieved from the one or more data sources can include historical and/or forecasted data identifying gross electrical energy demand on the power grid for a given time period. The energy usage information service 102 may then calculate the net demand by subtracting from the gross electrical energy demand, the amount of electrical energy contributed to the power grid by renewable energy sources during the same time period. In other examples, the net demand data 110 received from the one or more data sources can include actual historical and/or forecasted net demand information, where any calculations necessary to determine net demand have already been performed by the entity from which the net demand data 110 is acquired.

The energy usage information service 102 can also receive or retrieve the grid alert data 112 from the multiple data sources. Generally speaking, grid alerts are notifications or warnings issued by grid operators or utility operators (providers) about potential or actual issues affecting the reliability and stability of the power grid. These alerts can be used to communicate conditions that may require special attention, emergency actions, or adjustments to electrical energy generation, transmission, and consumption, and may be part of a broader system of grid management. The use of alerts can help to prevent problems such as blackouts and may help to resolve supply-demand imbalances by encouraging changes in customer behavior.

Different types of grid alerts may be issued by grid or utility operators. For example, a grid alert may be an energy shortage alert that can be issued when an available supply of electrical energy is approaching or has fallen below the required demand. Other grid alerts may include, for example, transmission congestion alerts that may be issued when there are limitations or constraints in the transmission network that prevent electrical energy from being delivered efficiently. Frequency and voltage alerts may be issued when the frequency or voltage of the electrical energy being transmitted by the power grid goes outside a normal operating range or when voltage fluctuations occur. When the grid alert data 112 includes a transmission congestion alert(s), the grid alert data 112 can also include information relative to the measure of electrical energy that a grid or utility operator can provide to a region. Grid alerts may additionally include generation loss alerts that may be issued when a significant electrical energy source experiences an unexpected shutdown or failure, or emergency alerts that may be issued relative to an expected or experienced widespread power outage or a large-scale generation or transmission failure. Grid alerts can also be weather-related alerts that may result from severe weather events that impact the power grid by disrupting electrical energy generation or transmission due to damaged transmission lines, extreme temperatures that might increase electrical energy demand, etc. In the case of a weather-related alert, the grid alert data 112 may include, for example, various weather related parameters, such as temperature, humidity, cloud coverage, and precipitation information. The weather information can be in the form of time series data.

In another example, a grid alert can be a flex alert. A flex alert is a specific type of proactive grid alert that may be issued by grid or utility operators, particularly in regions with high renewable energy contribution to the grid or where there is a risk of power supply shortages due to high demand, weather events, etc. A flex alert may include a request for customers to reduce electrical energy consumption during periods when the power grid is at risk of becoming strained, such as during periods of high demand, low electrical energy generation by the renewable energy sources, or a combination thereof.

Examples of the grid alert data 112 can include historical and/or forecasted data regarding the operating status of a given power grid during a given time period. For example, the grid alert data may indicate times when the grid has been or is forecasted to be under high strain. In the case of the historical data, the grid alert data may identify the particular types of alerts that have been issued, including nut not limited to the grid alert types identified above.

The energy usage information service 102 can also receive or retrieve the location marginal pricing (LMP) data 114 from the multiple data sources. Generally speaking, LMP is a pricing mechanism used to determine the cost of producing electrical energy at specific locations on the power grid. LMP reflects the marginal cost of supplying the next unit of electrical energy at a given location, and considers both the cost of generation and the costs associated with transmitting electrical energy across the power grid, including any transmission constraints. LMP also reflects the demand for electrical energy in a particular location. For example, high demand in certain regions may result in higher prices, as more electrical energy generation is needed to meet the increased demand. LMP is typically calculated by the grid operator at each location. The use of LMP can help ensure that prices reflect the true cost of delivering electrical energy and provides incentives for efficient generation, consumption, and investment in grid infrastructure.

Examples of the LMP data 114 can include historical data reflecting the wholesale price charged for generated electrical energy by a given provider at a given time (e.g., the preceding day). Likewise, the LMP data 114 can include forecasted data reflecting the wholesale price predicted to be charged for generated electrical energy by a given provider at a given time (e.g., a next day). The use of LMP allows wholesale electric energy prices to reflect the value of electrical energy at different locations, accounting for the patterns of load, generation, and physical limits of the associated transmission system.

Using the various data inputs 104-114, the energy usage information service 102 can generate at electrical energy usage guidance 116 and/or an electrical energy usage report and can, in this example, transmit the guidance or report directly or indirectly to a first user device 118. In some examples, the first user device 118 can be associated with an account of a customer of the power grid for which the data was acquired. The first user device 118 can present the guidance and/or report to the user. The electrical energy usage report can present historical user electrical energy consumption over some selected time period and may identify an amount of the consumption that was satisfied by a renewable energy source(s). The user may learn from the report how to improve their electrical energy usage habits. The user may use the electrical energy usage guidance to manage future energy consumption (i.e., how to shape their electrical energy consumption around the availability of renewable electrical energy). For example, the user can elect to use or recharge electrical energy consuming devices only during time windows identified in the guidance as being optimal for electrical energy production by renewable energy sources. The guidance may also consider the time-of-use (TOU) rate associated with energy consumption by the user when identifying such time windows. If enough users are encouraged to manage their electrical energy usage behavior in response to the guidance, power grid operators may also modify their behavior. For example, if a spike in demand occurs during a traditional renewable energy curtailment period, power grid operators may elect to not curtail renewable energy production during that time period.

In some instances, the first user device 118 can be associated with a smart home platform (e.g., Apple Homekit) and the user may have associated multiple user devices with the smart home platform. For example, the first user device 118 may be a smart phone and a second user device 120 also associated with the smart home platform may be a smart watch. In this example, the energy usage information service 102 can transmit the energy forecast to both the first user device 118 and the second user device 120.

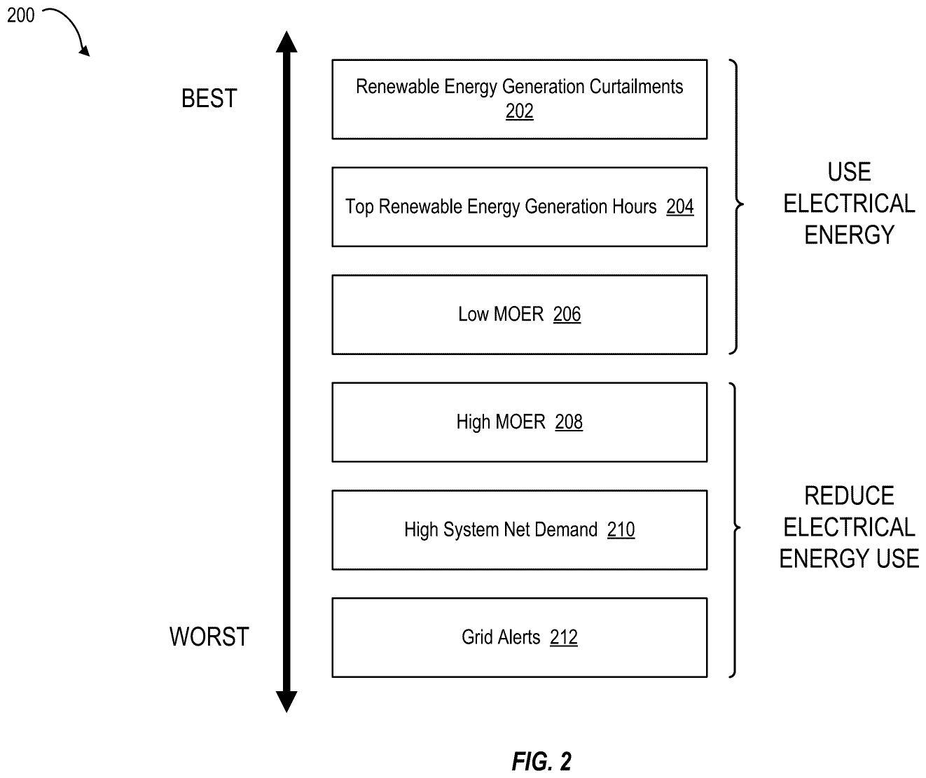

FIG. 2 is a block diagram illustrating intended results of employing the systems and techniques of the present disclosure. More specifically, FIG. 2 illustrates how potential events 200 (taken from FIG. 1 in this example) associated with supplying electrical energy to a power grid over the course of a given time interval can be classified and generally used to indicate when its best to use electrical energy and when its best to reduce electrical energy usage. This can lead to shaping individual electrical energy consumption and overall load on the power grid around the use of renewable energy resources. As shown, events including renewable electrical energy generation curtailments (“renewable energy generation curtailments”) 202, top renewable electrical energy generation hours (“top renewable generation hours”) 204, a low (lowest value) marginal operating emissions rate (MOER) 206, a high (highest value) MOER 208, a high system net peak (demand) 210, and grid alerts 212 are all identified as non-limiting examples of events that can occur in the course of supplying electrical energy to a power grid.

In the example of FIG. 2, a time of renewable generation curtailments 202 is identified as being the best time period within which to use electrical energy provided by the power grid. Contrarily, using electrical energy provided by the power grid at a time when the power grid is experiencing grid alerts 212 or will experience grid alerts 212 if additional electrical energy is withdrawn therefrom, is identified as being the worst time to use electrical energy provided by the power grid in this example. After a time period of renewable generation curtailments 202, the next best times to use electrical energy provided by the power grid are identified in this example as being during the hours of top renewable energy generation 204, followed by a time period within which a reaction by the power grid to an incremental increase in demand will result in only a minimal or low MOER 206. Similarly, after a time period during which the power grid is experiencing grid alerts or will likely experience grid alerts 212 if additional electrical energy is withdrawn therefrom, the next worst times to use electrical energy provided by the power grid are identified, in this example, as being during a time period of high system net demand 210 on the power grid, followed by a time period within which a reaction by the power grid to an incremental increase in demand will result in a high MOER 208.

The ordering (prioritizing) of time periods/windows illustrated in the example of FIG. 2 is, at least in part, a result of the goals and corresponding rules that can be established and used to guide operation of the systems and techniques of the present disclosure. These goals and rules can change and, therefore, the ordering depicted in FIG. 2 may be different in other examples. For example, depending on factors such as the architecture of the power grid, the mix of renewable and nonrenewable energy sources providing electrical energy thereto, the weather in the region of the power grid, and demand on the power grid, there may historically have been few curtailments of the renewable energy sources. In such an example, it may be possible that using electrical energy provided by the power grid during a time period(s) of top renewable energy generation 204 is prioritized over using electrical energy at a time of or during a time period of renewable generation curtailments 202.

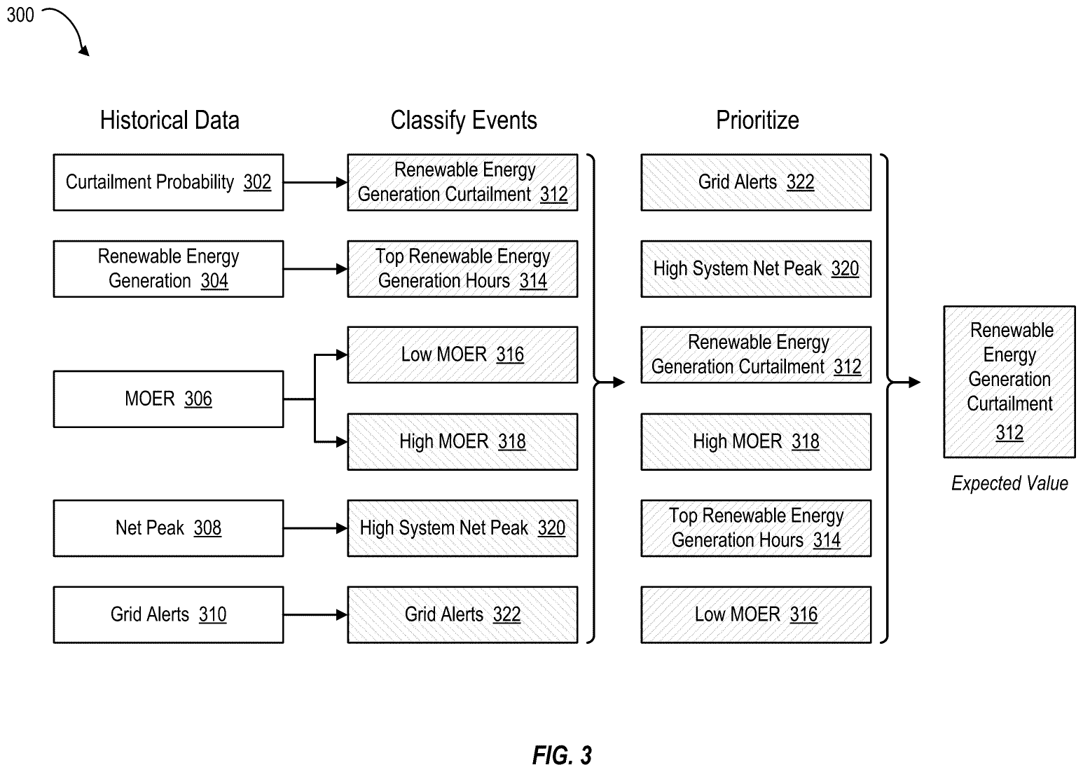

FIG. 3 is a block diagram illustrating, at a high level, an operation 300 for creating a historical energy (target) signal. The historical energy signal may be created, according to one or more embodiments, by identifying, classifying, and prioritizing historical events present in a historical dataset generated from data obtained from various sources and associated with operation of a power grid over the course of a given past time period. The historical events may reflect various historical conditions of the power grid. As indicated in FIG. 3, the historical dataset includes curtailment probability data 302. Renewable energy generation information 304 is also present in the dataset. The renewable energy generation information 304 may generally include information regarding renewable energy production, such as historical solar power energy generation data and historical wind power energy generation data or the like. As can also be observed, the historical data includes MOER data 306 that reflects how efficiently the power grid reacted to an incremental increase in the demand for electrical energy by procuring electrical energy from an additional energy source. Likewise, net peak (demand) data 308 and grid alert data 310 is also present in the historical data from the one or more data sources and has been acquired.

A historic energy (target) signal may be generated as generally described above and under the guidance of a set of goals and rules. As previously stated, one goal can be to encourage the usage of electrical energy supplied to a given power grid by one or more renewable energy sources and to discourage the usage of electrical energy supplied to the power grid by one or more nonrenewable energy sources. The set of goals and rules applied to creating the historic energy (target) signal may be different indifferent embodiments.

In this example, six events have been identified as being simultaneously present in the data streams 302-310 at a given time interval within the example time period. In this example, the six events are classified as a renewable energy generation curtailment event 312, top renewable energy generation hours event 314, a low MOER event 316, a high MOER event 318, a high system net peak demand event 320, and a grid alerts event 322. In one example, the rules used to define these events can classify a curtailment event when the curtailment probability exceeds some percentage per balancing authority. For example, rules may classify a curtailment event when the curtailment probability exceeds 25% per balancing authority. This percentage can vary based on the balancing authority location (e.g., the percentage might be 35% or 50% in some cases). In some examples, the rules can also define top renewable energy generation hours as being in the top 20% of renewable energy generation in a day if a high MOER is not occurring and there is a minimum amount of renewable energy generation. In some examples, the rules can specify that a low MOER is a MOER in a bottom 10^{th} percentile of all MOERs that occurred within the given time period associated with the data streams (e.g., one day), and that a high MOER is a MOER in a top 90% of all MOERs that occurred within a given time period (e.g., one year). The rules may additionally state that the high system net peak is defined as net demand within a top 50-200 hours in a given time period (e.g., year/season). Other rules may be developed and applied in other examples.

As shown in FIG. 3, the classified events 312-322 can then be prioritized. In this example, the prioritized order indicates that avoiding energy usage during grid alert events 322 is of most concern (highest priority) followed by avoiding energy usage during times of high system net peak demand 320, using electrical energy during periods of renewable energy generation curtailment 312, avoiding energy usage during periods of high MOER 318, and using electrical energy during periods of top renewable energy generation hours 314. In this example, using electrical energy during periods of low MOER 316 is assigned the lowest priority. The example priority order represented in FIG. 3 may arise, for example, because a grid alert event 322 can indicate or result in a shutdown of an electrical energy generation source(s), serious problems with the power grid or transmission operations associated therewith, or undesirable results of such problems such as blackouts. Similarly, the high system net peak even 320 may indicate that the power grid is reaching a point where the demand for electrical energy may soon exceed the supply. As such, it may inadvisable to use electrical energy during such time periods.

In determining the highest priority classified event, both the goals and the rules that are used to direct the classification and prioritization operations should be considered. According to the present disclosure, one goal is to increase reliance of the power grid on renewable energy sources and to decrease reliance of the power grid on nonrenewable energy sources—i.e., to shape the load on the power grid around available renewable energy sources. Consequently, despite the grid alert event 322 being designated as the highest priority event based on application of the rules, the renewable energy generation curtailment event 314 is ultimately determined to be the highest priority event. In this example, the renewable energy generation curtailment event 314 is designated as the highest priority event upon further consideration of the goals and upon a determination that the renewable energy generation curtailment event 314 is not only occurring but is occurring within a time window associated with the top renewable energy generation hours event 316 of the time given period. In other words, operation of a renewable energy source(s) associated with the power grid is being curtailed at the very time during which electrical energy generation by the renewable energy source is at an optimum.

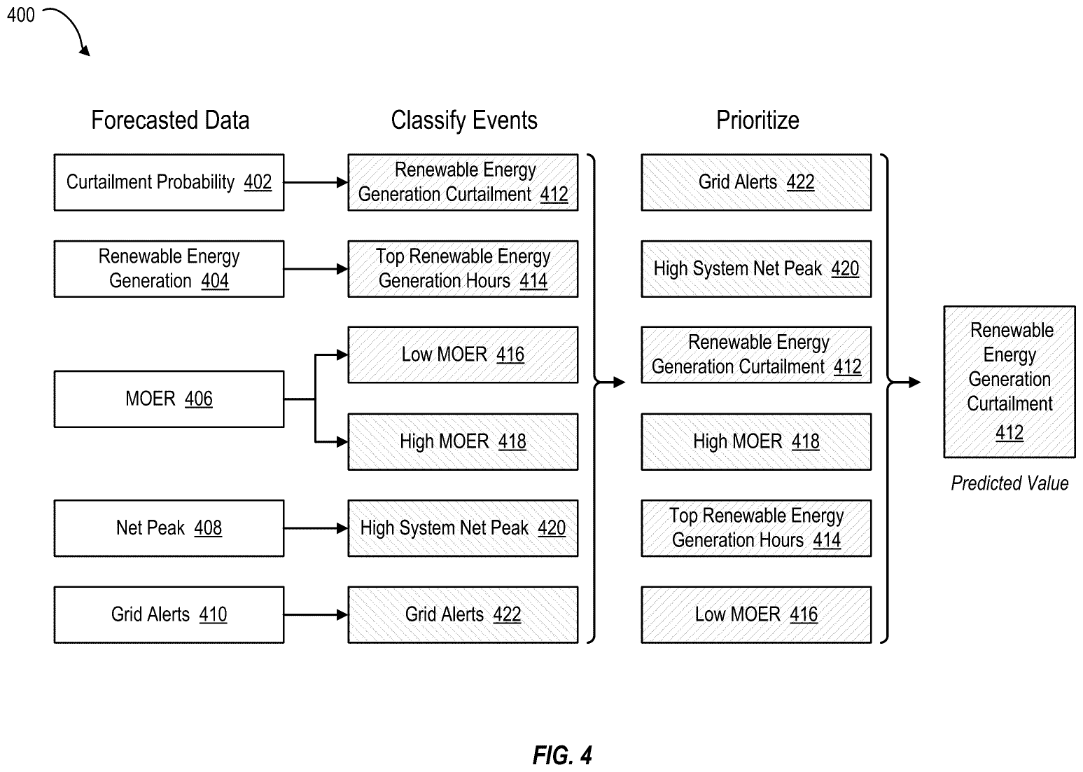

FIG. 4 is a block diagram illustrating, at a high level, an operation 400 for creating a forecasted energy signal. The forecasted energy signal may be created, according to one or more embodiments, by identifying, classifying, and prioritizing events present in a forecasted dataset generated from data obtained from various sources and associated with the operations of a power grid over the course of a future time period. In some embodiments, the generated forecasted dataset may also include at least some historical data.

As indicated in FIG. 4, the example of the forecasted dataset includes curtailment probability data 402 and forecasted renewable energy generation data 404. The renewable energy generation data 404 may include like or similar information as described above with respect to the renewable electrical energy generation data 304 of FIG. 3. As can also be observed, the forecasted data can include historic MOER data 406, which may or may not be from the same data source as the MOER data 306 of FIG. 3. Likewise, net peak (demand) data 408 and grid alert data 410 can also be present in the forecasted data. The net peak data 408 may be derived from historic demand data in some examples, and the grid alert data 410 may also be historic data.

In the example of FIG. 4, it can be observed that the forecasted dataset and the classified events are the same as those shown in FIG. 3. This duplication is merely for purposes of illustration. It should be understood that the classified events reflected in the forecasted data may not be the same as the classified events reflected in the historical data according to some examples, but my nonetheless still reflect various conditions of the power grid. Additionally, while not impossible, it is unlikely that all six of the classified events would occur during the same time interval, especially given that many of the time periods associate therewith are relatively short.

A forecasted signal may be generated, at least in part, by using a machine learning (ML) model operating under a set of goals and rules as generally described above with respect to FIG. 2. As previously stated, one goal of an energy usage information service and associated method of use can be to encourage the usage of electrical energy supplied to a given power grid by one or more renewable energy sources and to discourage the usage of electrical energy supplied to the power grid by one or more nonrenewable energy sources. The set of rules applied to creating the forecasted energy signal may be different in different embodiments.

Various types of ML models may be used to generate portions of the forecasted signal. Examples may include, without limitation, XGBoost, TiDE, and various transformer models that are good at performing long-term time series forecasting. In some instances, the energy usage information service 102 can use a machine learning model that implements a forecasting technique such as, for example, autoregressive integrated moving average (ARIMA), exponential smoothing, gradient boosting, Prophet, or a forecasting service. In some instances, the energy usage information service may 102 provide forecasted values along with the historical data. In addition to the forecasted values, the forecasting data can include various forecasting parameters identified by the machine learning model or information service. The forecasting parameters can include, for example, seasonality, trends, outliers, and other appropriate parameters.

In this example, six events have been identified as being simultaneously present in the data streams 402-410 at a given time interval within the example time period. In this example, the six events are classified as a renewable energy generation curtailment event 412, a top renewable energy generation hours event 414, a low MOER 416 event, a high MOER 418 event, a high system net peak 420 event, and a grid alerts event 422. In various examples, the rules used to define these events can be the same as those described above relative to the target signal creation operation of FIG. 3.

As shown in FIG. 4, the classified events 414-422 can then be prioritized. In this example, the prioritized order indicates that avoiding energy usage during the grid alerts events 422 is of most concern (highest priority) followed by avoiding energy usage during times of high system net peak demand 420, using electrical energy during periods of renewable energy generation curtailment 412, avoiding energy usage during periods of high MOER 418, and using electrical energy during periods of top renewable energy generation hours 414. In this example, using electrical energy during periods of low MOER 416 is assigned the lowest priority. The example event priority order represented in FIG. 4 may arise, for example, for the same or similar reasons descried above with respect to the event priority of FIG. 3.

In determining the highest priority classified event according to the present disclosure, both the goals and the rules that are used to direct the classification and prioritization operations must be considered. According to the present disclosure, a particular goal is to increase reliance of the power grid on renewable energy sources and to decrease reliance on nonrenewable energy sources—i.e., to shape the load on the power grid around available renewable energy sources. Consequently, despite the grid alerts event 422 being designated as the highest priority event based on application of the rules, renewable energy generation curtailment 414 is ultimately determined to be the highest priority event. In this example, renewable energy generation curtailment 414 is designated as the highest priority event upon further consideration of the goals and upon a determination that renewable energy generation curtailment 414 is not only occurring but is occurring within a time window associated with the top renewable energy generation hours 416 of the time given period. In other words, operation of a renewable energy source(s) associated with the power grid is being curtailed at the very time during which electrical energy generation by the renewable energy source is at an optimum.

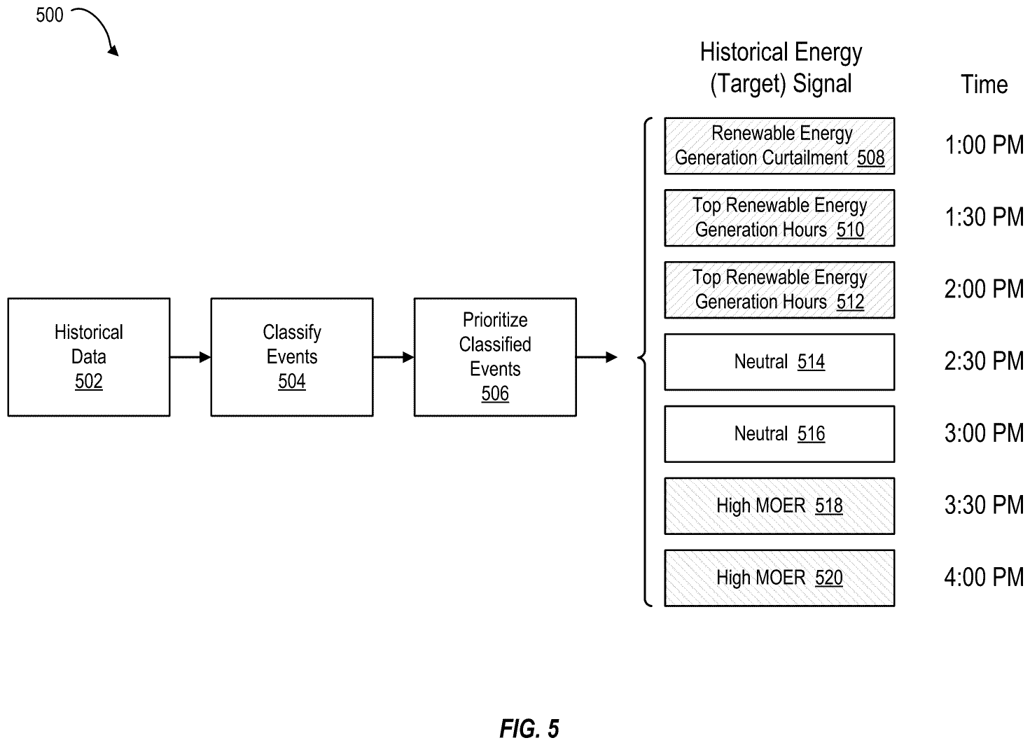

FIG. 5 is a block diagram further illustrating an operation 500 to create a historical energy (target) signal by identifying, classifying, and prioritizing events present in historical data 502 associated with the operations of a power grid over the course of a given time period. The operation may be implemented in the same manner or in a manner similar to the target signal creation operation described with respect to FIG. 3. The historical data 502 may once again be acquired from one or more of multiple possible data sources, including any of the data sources identified above. At 504, the events may be classified and at 506 the classified events may be prioritized in a like or similar manner that that described with respect to the operation of FIG. 3.

As previously described, the data is time series data (e.g., recorded at regular time intervals over some period of time). Consequently, FIG. 5 reflects that performing a series of classification and prioritization operations on a corresponding series of historical data time intervals can produce a historical energy signal including multiple time dependent highest priority events. That is, each highest priority event 508-520 may be associated with a given finite time interval (e.g., 30 minutes) of data. It can also be observed in FIG. 5 that different highest priority events can be calculated for different data time intervals. This can be due to a host of factors, including for example, changing environmental conditions, changing conditions of the power grid, or changing conditions of a renewable resource(s) used to supply electrical energy to the power grid.

In the example of FIG. 5, it can be observed that the initial highest priority event corresponding to a time period between 1:00 PM to 1:30 PM is a renewable energy generation curtailment event 508. This may indicate that the output of one or more renewable energy sources is expected to be curtailed at that time. The highest priority event corresponding to a time period between 1:30 PM to 2:00 PM and between 2:30 PM to 3:00 PM is a top renewable energy generation hours event 510, 512. This can indicate, for example, that the time period between 1:30 PM to 2:30 PM is an optimum time to generate renewable energy at a given renewable energy source(s) location. For example, sun energy received by a solar power plant or wind energy received by a wind turbine power plant may be particularly strong within that time period. This may also indicate that the renewable energy generation curtailment event 508 has ended by 1:30 PM, or that generating electrical energy during the top renewable energy generation hours 510, 512 is simply a more productive option. It may also be observed that the event classification and prioritization operation may sometimes fail to return a highest priority event. For example, the time period between 2:30 PM to 3:30 PM is shown to be considered neutral with respect to renewable energy generation. Generally speaking, this can mean that it is not particularly beneficial nor particularly detrimental to the goals of the present disclosure to use electrical energy provided by the power grid during this time. FIG. 5 further represents that a classification and prioritization operation can also identify a high priority event to avoid. In this case it has been determined that within the time period from 3:30 PM to 4:00 PM, causing the power grid to react to an incremental increase in demand could result in a high MOER. Thus, consuming electrical energy from the power grid during this time period could have negative consequences on the environment (e.g., increased greenhouse gas emissions).

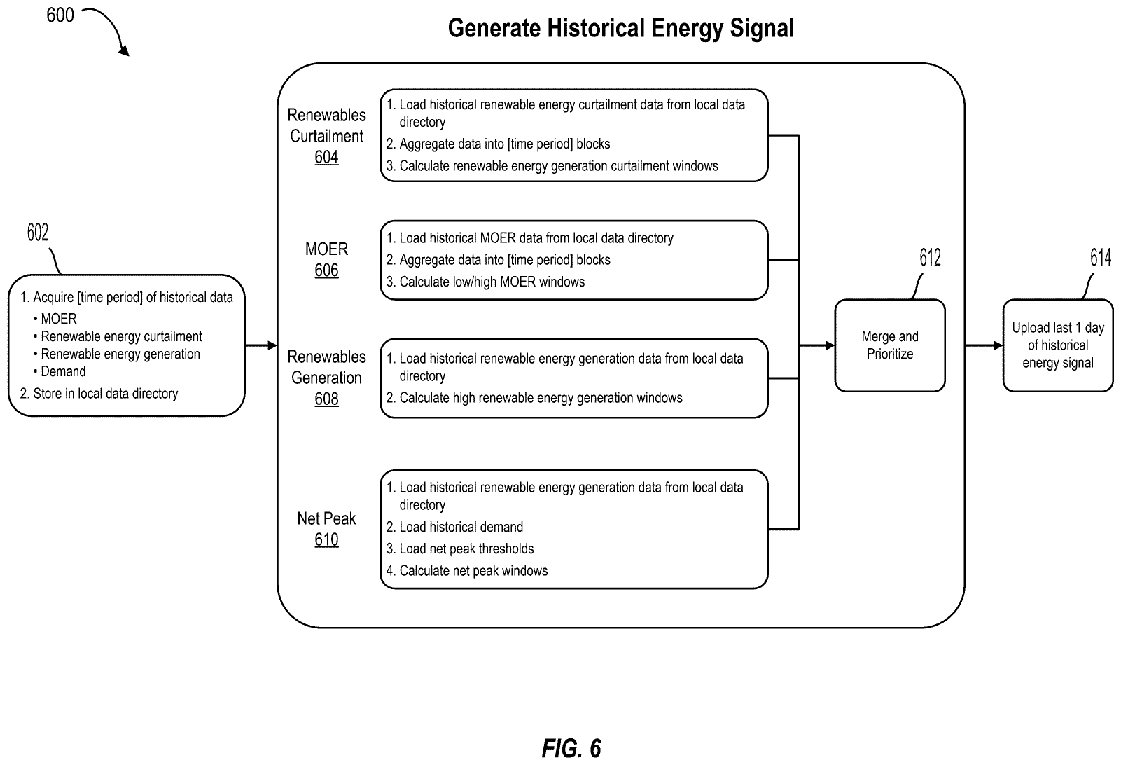

FIG. 6 illustrates a process flow for generating a historical energy signal (i.e., a target signal) using a computing system, such as the computing system of the energy usage information service 102 of FIG. 1 according to one or more embodiments. As shown, the process includes at 602, acquiring historical data for a selected time period from one or more sources that includes MOER data, renewable energy curtailment event data, renewable energy generation data, and data indicating the historical demand on a given power grid. The acquired data may be stored in a local data directory (e.g., as a generated dataset). In various embodiments, the local data directory may or may not be part of the computing system.

At 604, the historical renewable energy curtailment data can be retrieved from the local data directory and loaded to the computing system. In some examples, historical renewable energy curtailment data can be obtained from providers such as ISOs or RTOs. The historical renewable energy curtailment data is a time series that indicates the amount of electrical energy (e.g., in megawatts) that is curtailed at a given time X. Depending on the ISO/RTO, there may be an indication as to whether the curtailment is addressable or if the curtailment is localized (e.g., constrained by transmission). In another example, a time series of data that indicates the “probability” of curtailment at given times in 5 minute increments may be obtained from the environmental non-profit organization WattTime. The historical renewable energy curtailment data may be aggregated into blocks spanning a plurality of desired time periods (e.g., 30 minutes), and the renewable energy generation curtailment windows can be calculated using the data and an algorithm guided, at least in part, by the aforementioned goals and rules.

At 606, the historical MOER data can be retrieved from the local data directory and loaded to the computing system. The historical MOER data is time series data. In some examples, historical MOER data may have a 5 minute granularity that is a combination of a last predicted point(s) and a different model that uses additional data and is available after the generation time. The data may be aggregated into blocks spanning a plurality of desired time periods (e.g., 30 minutes), and low MOER windows and high MOER windows can be calculated.

At 608, the historical renewable energy generation data can be retrieved from the local data directory and loaded to the computing system. In some examples, the historical renewable energy generation data may be obtained from, for example, government sources such as the U.S. Energy Information Association (EIA). The historical renewable energy generation data may also be a per balancing authority (BA) data source containing generation per fuel type, carbon intensity, demand, and/or demand forecast as (e.g., hourly) time series. Depending on the source, the historical renewable energy generation data may be updated every 24 hours. The high renewable energy generation windows can then be calculated.

In at least some examples, part of the operation of calculating renewable energy generation windows can include determining a daily peak generation value for solar power and solar power plus wind data streams, and then defining an acceptable window that encompasses at least some amount of the peak (i.e., a window around the peak). This can help to shape the load under the peak. In one example, a window may be defined by multiplying the peak generation value by a factor to calculate a range and then considering any values that fall within the range to be within the window. For example, if the total peak generation value of a solar-powered renewable energy source is 500 kWh on a given day and the factor is 80% (0.8), then any generation values above 400 kWh (i.e., in the top 20%) can be considered to fall within the window.

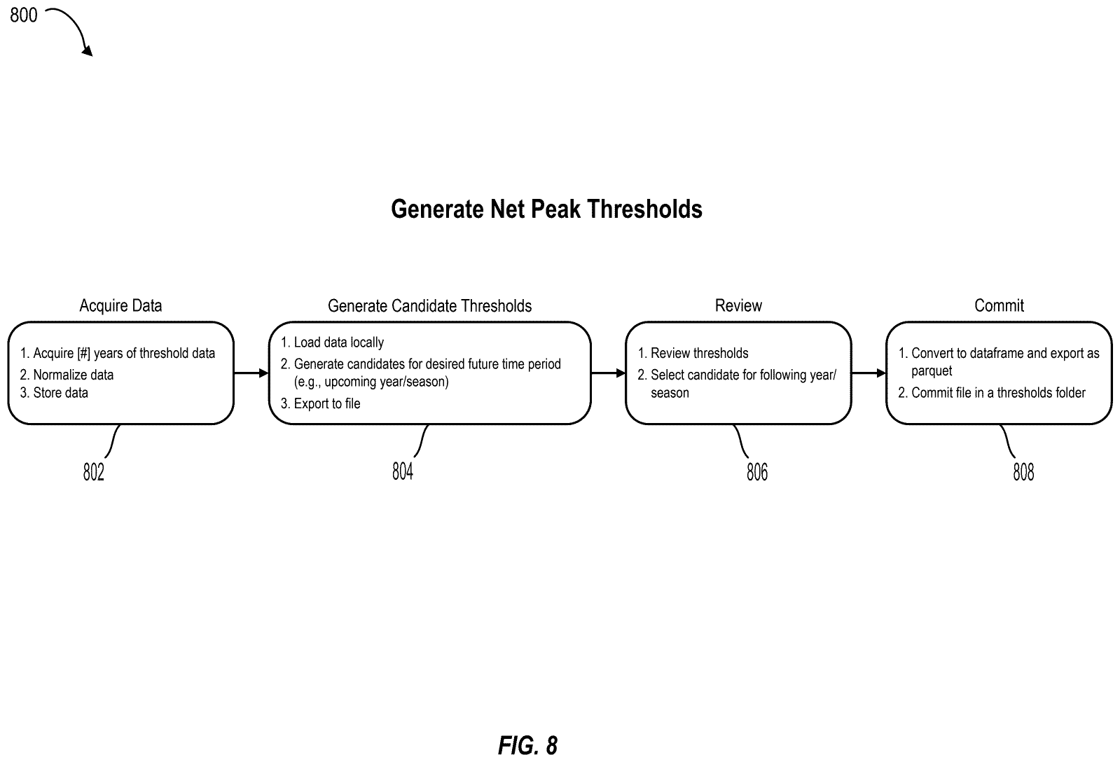

At 610, the historical renewable energy generation data can be retrieved from the local data directory and loaded to the computing system along with historical demand and net peak demand thresholds (described in more detail below in regard to FIG. 8). The net peak windows can then be calculated using, among other things the net demand and the net peak thresholds data.

At 612, the calculated renewable energy generation curtailment windows, the predicted low MOER windows and high MOER windows, the calculated high renewable energy generation windows, and the calculated net peak windows can be merged and prioritized. At 614, a target signal can be created therefrom as previously described and a last time period (e.g., 1 day) of the historical energy (target) signal can be uploaded to the computing system.

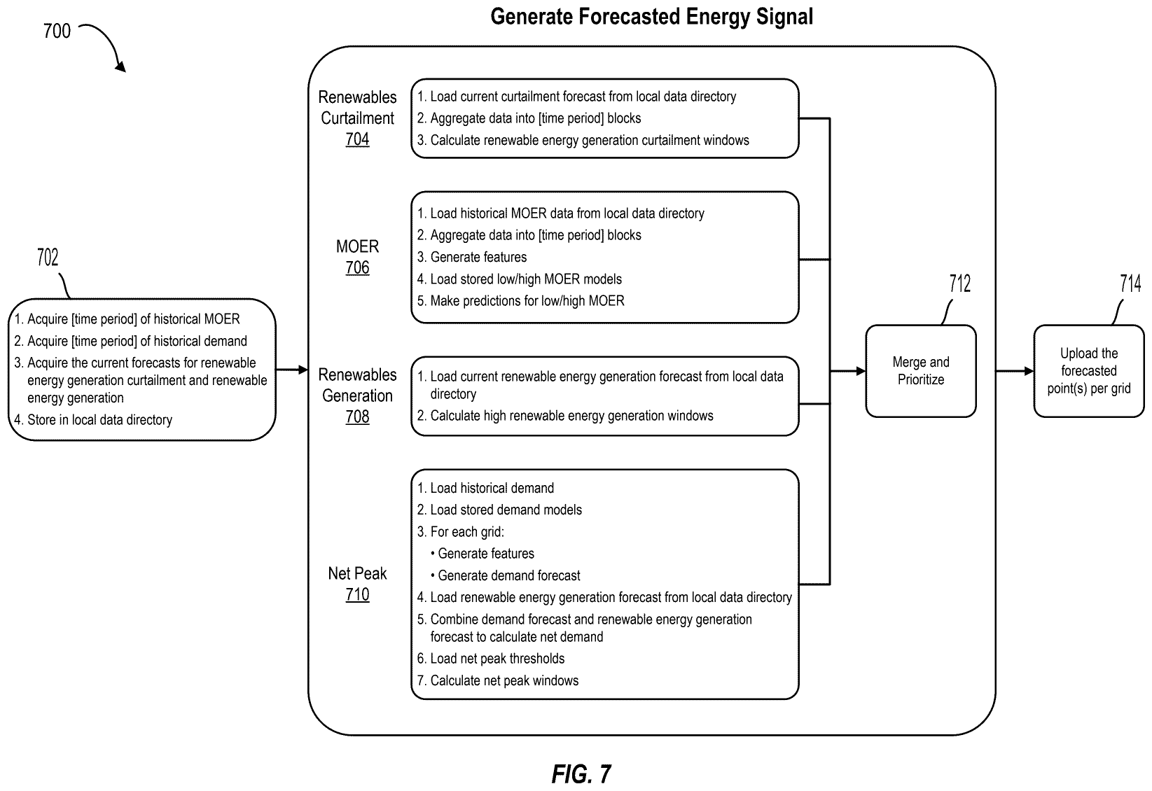

FIG. 7 depicts one example of a process flow for generating a forecasted energy signal using a computing system, such as the computing system of the energy usage information service 102 of FIG. 1. As shown, this example of the process includes at 702, acquiring current forecasted renewable energy generation curtailment data and forecasted renewable energy generation data (from, e.g., WattTime). Historical MOER data and historical demand data can also be acquired. The acquired data may be stored in a local data directory (e.g., as a generated dataset). The local data directory may or may not be part of the computing system in various examples.

At 704, the current renewable energy curtailment data can be retrieved from the local data directory and loaded to the computing system. The current renewable energy curtailment data may be aggregated into blocks spanning a plurality of desired time periods (e.g., 30 minutes), and renewable energy generation curtailment windows can be calculated using the current renewable energy curtailment data and an algorithm guided, at least in part, by the aforementioned goals and rules.

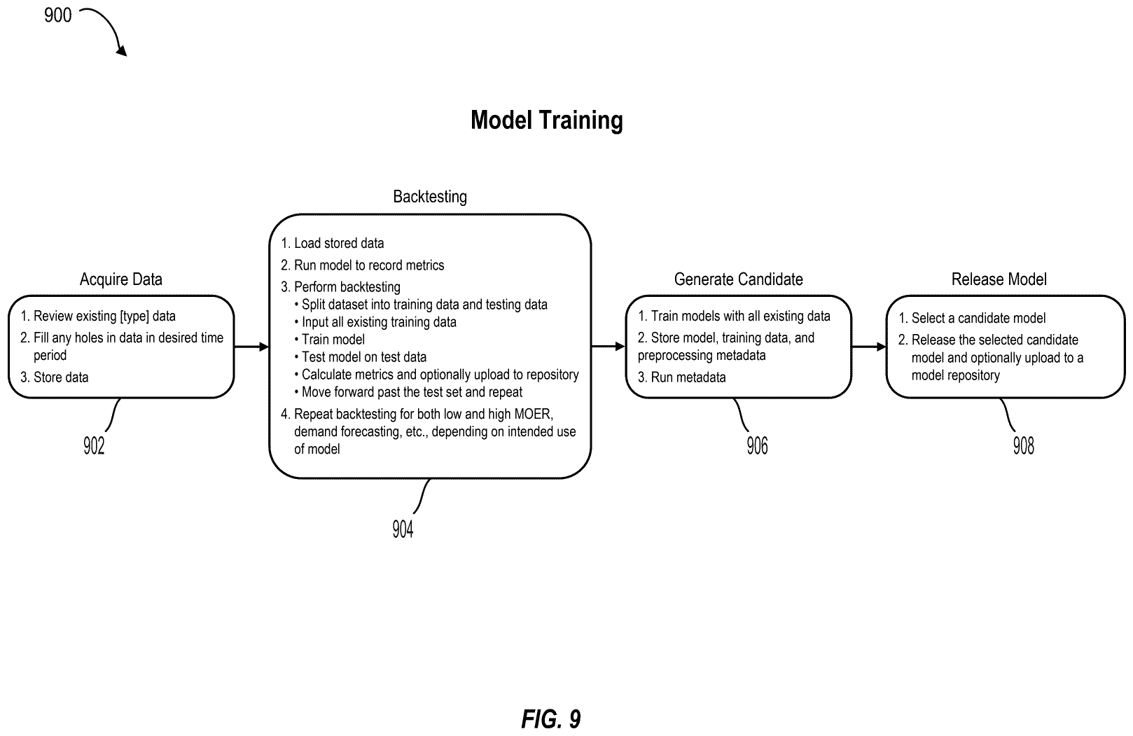

At 706, the historical MOER data can be retrieved from the local data directory and loaded to the computing system. The historical MOER data is time series data. In some examples, historical MOER data may have a 5 minute granularity that is a combination of a last predicted point(s) and a different model that uses additional data and is available after the generation time. The data may be aggregated into blocks spanning a plurality of desired time periods (e.g., 30 minutes). Feature engineering may be utilized to generate features that can improve a subsequent modeling operation. For example, lag features (values of variables at a previous time step) and windows features can be generated used to transform the time series MOER data into tabular data. Other features such as exogenous features may also be generated and used to improve the performance of the energy signal forecasting operation. Previously trained and stored low MOER and high MOER models (see FIG. 9) can be loaded to the computing system or to another computing system hosting the MOER models. The previously trained low MOER and high MOER models may then be used to predict low MOERs and high MOERs resulting from a reaction of the power grid to incremental increases in demand.

At 708, the current renewable energy generation forecast data can be retrieved from the local data directory and loaded to the computing system. High renewable energy generation windows can then be calculated using the current renewable energy generation forecast data and an algorithm guided, at least in part, by the aforementioned goals and rules. In at least some examples, the high renewable energy generation window calculations described above relative to FIG. 6 may also be applied when calculating the high renewable energy generation windows according to the operations of FIG. 7. That is, a window may be defined by multiplying a daily peak generation value for the renewable energy source by a factor to calculate a range and then considering any values that fall within the range to be within the window in the same manner described above with respect to FIG. 6.

At 710, previously trained and stored demand models (see FIG. 9) can be loaded to the computing system or to another computing system hosting the demand models, and the historical demand data can be retrieved from the local data directory and loaded to the modeling computing system. For each power grid for which an energy signal will be forecast, features may thereafter be generated and the demand models may be used to predict a demand forecast. The renewable energy generation forecast can then be loaded to the computing system from the local data directory or to another computing system communicatively coupled to the computing system and the forecasted demand can be combined with the forecasted renewable energy generation to calculate net demand. Net peak demand thresholds (described in more detail below in regard to FIG. 8) can then be loaded to the computing system and net peak demand windows can be calculated using the net demand data and the net peak thresholds.

At 712, the calculated renewable energy generation curtailment windows, the predicted low MOER windows and high MOER windows, the calculated high renewable energy generation windows, and the calculated net peak demand windows can be merged (i.e., grouped) and prioritized. At 714, a forecasted energy signal can be created therefrom as previously described and the forecasted point(s) per grid can be uploaded to the computing system.

FIG. 8 depicts one example of a process flow for generating net peak thresholds using a computing system, such as the computing system of the energy usage information service 102 of FIG. 1. As shown, the process includes at 802, acquiring a desired number of years of historic threshold data from the above-described one or more data sources, although the extent of the threshold data may be less in other examples. Given the potential breadth and age range of the threshold data, the threshold data may be normalized by one or more of various normalization techniques. For example, min-max normalization, z-score normalization, or scaling techniques may be used to normalize the threshold data. Normalizing the threshold data can help to ensure that features in the threshold dataset share a common scale, which can improve the performance of ML models that utilize the net peak threshold data generated therefrom. After being normalized, the threshold data can be stored in a local data directory.

At 804, the stored threshold data may be loaded to the computing system or to another modeling computing system. A ML model can then be used to generate candidate threshold values for a desired future time period (e.g., a following year/season). A plurality of candidate thresholds can thereafter be optionally exported to a file. At 806, the plurality of candidate thresholds may be reviewed and a candidate threshold of the plurality of candidate thresholds may be selected for use during the future time period. At 808, the selected candidate file may be converted to a structured tabular format (e.g., dataframe) at least to facilitate use of the selected threshold in a machine-learning based determination of net peak demand windows as described above with respect to generating the historical (target) energy signal (see FIG. 6) and the forecasted energy signal (see FIG. 7). In one example, the threshold candidate file may be exported in Apache Parquet format. The selected threshold value file may also be committed/stored, such as in a thresholds folder or another suitable storage location.

FIG. 9 is a flow diagram depicting one example of a machine learning (ML) model training methodology 900. For example, the training methodology 900 can be used to train a ML model to classify or prioritize events, or to generate a historic energy (target) signal or a forecasted energy signal. The training methodology 900 can also be used to train a ML model to be a MOER model that predicts occurrences of low or high MOER events, or a demand model that predicts energy demand (i.e., generates demand forecasts). The training methodology 900 can also be used to train a ML model to generate other outputs that are usable in a process of generating energy usage guidance or otherwise shaping the load on a power grid around available renewable energy resources rather than nonrenewable energy resources. While various training operations are shown as being part of the ML model training methodology 900, it should be understood that the ML model training methodology 900 of FIG. 9 is presented herein only as an example and other techniques for training a ML model for use with system and method embodiments according to the present disclosure are certainly possible.

The ML model training methodology 900 is shown to include a first data acquisition operation 902 where existing data of a particular type is acquired and initially reviewed. For example, when the ML model is trained to predict low MOERs and high MOERs, the data may be historical MOER data acquired from one or more of the various types of data sources previously described. Alternatively, when the ML model is trained to predict a demand forecast, the data may be historical demand data acquired from one or more of the various types of data sources previously described. In any case, the acquired data may be reviewed, holes in the data in a desired time period may be filled, and the data may be stored.

A backtesting operation 904 may be performed subsequent to data acquisition. The reviewed and possibly repaired stored data may be loaded to a computing system used to train ML models. In some embodiments, the computing system may be the energy usage information service 102 computing system. In other embodiments, a separate computing system may be used to train machine models. In such an embodiment, the separate computing system may be communicatively coupled to the information service 102 computing system. In other examples, the model training computing system may include one or more physical or virtual servers of a cloud based service provider. In some examples, the model may be trained within the space of an online model repository.

The ML model may be a pretrained model, and more particularly, a pretrained model that is adept at forecasting time series data. For example, the pretrained model may implement a time series data forecasting technique such as an autoregressive integrated moving average (ARIMA) technique, a seasonal autoregressive integrated moving average (SARIMA) technique, or may be a MLP-based encoder-decoder model such as TiDE, a gradient boosting model such as XGBoost, or a neural network such as a transformer model. In any case, the selected ML model(s) can receive the data as input and generate an output including the forecast. The forecast can be for a configurable time interval. For example, the computing system can use the machine learning model to forecast, for example, the next six hours, a next day, or a next week.

As an initial step of the backtesting operation 904, the chosen model may first be run to record metrics. For example, the chosen model may be run on any model testing computing system described above including an online model repository such as MLHub, or otherwise on a different computing system. The actual backtesting of the model may then be performed. In some examples, backtesting may include splitting the stored data (e.g., time series data associated with the operation of one or more power grids of a given region) into a training dataset and a testing data set. The backtesting operation 904 may further include training the chosen model using the training data set and subsequently testing the trained model using the test dataset. In some examples, the entirety of the data in the training dataset may be used to train the model and the entirety of the data in the test dataset may be used to test the model. The operational metrics of the trained model may then be calculated and the trained model may be optionally uploaded to a model repository. Further testing of the trained model may be performed using a data set(s) other than the test dataset. For example, depending on the intended use of the trained model (e.g., low and high MOER prediction, demand forecasting), the trained model may be further tested using appropriate data (e.g., historical MOER data, historical demand data).

The backtesting operation 904 may be performed on multiple pretrained models at least for the purpose of comparing model performance and for ultimately generating a candidate model at a subsequent candidate model generation operation 906. The candidate model generation operation 906 may include, for example, further training all the selected models with all existing training data and also preprocessing metadata. Generating a candidate model may further include running the metadata. In some examples, the metadata can be run in a distributed machine learning environment, and may be stored at a cloud service provider.

At 908, a candidate model can be selected for use from a plurality of candidate models generated at the candidate generation operation 906. Once the candidate model is selected, the model can be released for use. In some examples, the model may be uploaded to a machine learning repository (e.g., MLHub).

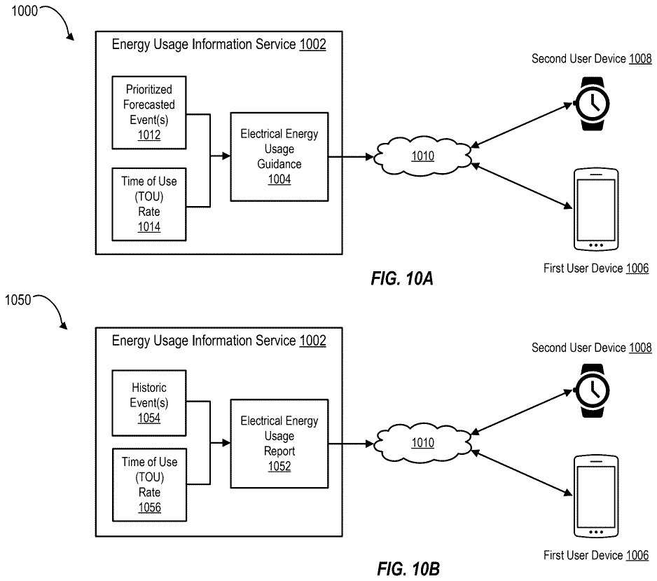

FIG. 10A is a schematic diagram illustrating an environment 1000 in which a computing system (energy usage information service) 1002 can generate forecasted electrical energy usage guidance (“energy usage guidance”) 1004 and transmit the guidance or cause the guidance to be transmitted to one or more user devices according to one or more embodiments. In this example, the user devices may be a first user computing device 1006 in the form of a smart phone and a second user computing device 1008 in the form of a smart watch. The energy usage guidance 1004 may be transmitted from the energy usage information service 1002 to the user devices 1006, 1008 via a network 1010, which in this example is the Internet.

The energy usage guidance 1004 can be based on prioritized forecasted events data 1012 that is generated by the energy usage information service 1002 as described above with respect to, for example, FIGS. 3-7. For example, the energy usage guidance 1004 transmitted to the first and second user devices 1006, 1008 may provide information like or similar to that shown in FIG. 5, where various optimal windows (or one window) of opportunity to use electrical energy supplied to an associated power grid by one or more renewable energy sources are identified. As in FIG. 5, the energy usage guidance 1004 may also identify one or more time windows where the usage of electrical energy from the power grid is discouraged to avoid contributing additional greenhouse gases from nonrenewable energy sources to the atmosphere (e.g., during times of high MOER). The energy usage guidance 1004 may be presented in numerous ways, including graphically, textually, or by combinations thereof. In any case, a goal of the energy usage guidance 1004 can be to encourage the user of the devices 1006, 1008 to consume electrical energy generated by renewable energy sources and to discourage the user from consuming electrical energy generated by nonrenewable energy sources.

As indicated in FIG. 10A, the energy usage guidance 1004 may also consider the time-of-use (TOU) rate 1014 associated with the location of the devices 1006, 1008 or the user of the devices 1006, 1008. Use of the TOU rate 1014 can enable the energy usage information service 1002 to refine the energy usage guidance 1004 by identifying optimal electrical energy consumption windows that are based not only on renewable energy source generation but also on the cost of the electrical energy to the user.

FIG. 10B, like FIG. 10A illustrates an environment 1050 wherein the energy usage information service 1002 can generate electrical energy usage information (“energy usage information”) and transmit the energy usage information or cause the energy usage information to be transmitted to the user devices 1006, 1008 according to one or more embodiments. In the example of FIG. 10B, however, the energy usage information service 1002 transmits to the user devices 1006, 1008 a historical electrical energy usage report (“energy usage report”) 1052 that provides the user with information regarding the user's historical electrical energy consumption over some selected time period. In that regard, the energy usage report 1052 can be based on historic events data 1054 that is acquired by the energy usage information service 1002 as described above with respect to, for example, FIGS. 3-7. In some examples, the energy usage report 1052 may identify an amount of the electrical energy consumption by the user that was satisfied by a renewable energy source(s). While the user may not be able to accurately plan future electrical energy consumption using the energy usage report 1052, the user may nonetheless learn from the report how to improve their electrical energy usage habits. As with the energy usage guidance 1004, the energy usage report 1052 may make use of historic TOU rate data 1056 associated with the user to present the user with a picture of their historic electrical energy costs and possibly with cost saving tips. The energy usage report 1052 may also be transmitted from the energy usage information service 1002 to the user devices 1006, 1008 via the network 1010.

The energy usage guidance 1004 and energy usage report 1052 transmission examples presented in FIGS. 10A and 10B are simplistic in the sense that the guidance is provided directly to user devices by a grid operator or a provider such as a utility. In some examples, this may merely require the grid operator or the utility operator to have contact information for the user of the devices 1006, 1008. In such a case, the energy usage guidance 1004 or the energy usage report 1052 may be transmitted as a message of some format, in the form of notifications, including push notifications using the Apple Push Notification service (APNs), or as in-app notifications that may appear as an in-line popups on a user interface of the user devices 1006, 1008. In other examples, the user devices 1006, 1008 may execute an application that is managed by the grid operator or the utility operator and through which the energy usage guidance 1004 can be provided to the user.

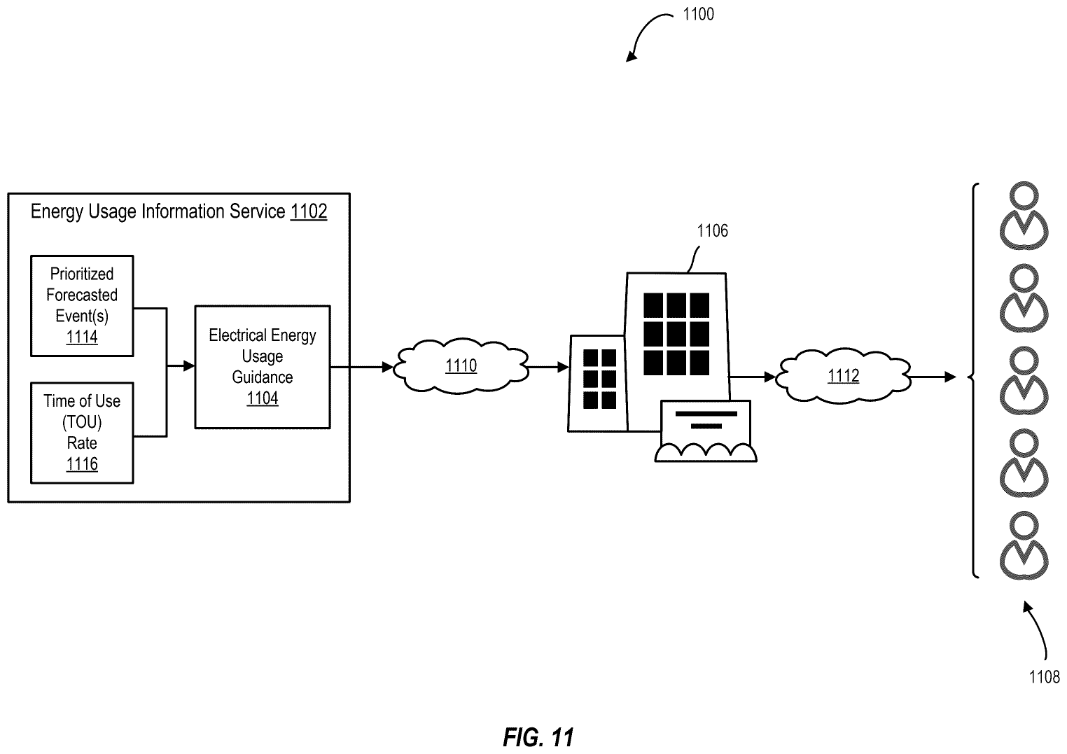

FIG. 11 is a schematic diagram illustrating an environment 1100 in which a computing system (e.g., energy usage information service) 1102 can generate multiple unique instances of forecasted electrical energy usage guidance (“energy usage guidance”) 1104 and can transmit the unique guidance instances or cause the unique guidance instances to be transmitted to an entity 1106 for the benefit of customers 1108 or other users associated with the entity 1106. The entity 1106 may be, for example, a corporate entity according to some embodiments. For example, the entity 1106 may be a manufacturer of electric vehicles and the customers 1108 may be owners of the manufacturer's electric vehicles, which are charged using electrical energy provide through a power grid. In such an example, the customers 1108 may desire to know, and/or the entity 1106 may desire to provide the customers 1108 with guidance, regarding a best time(s) to charge their electric vehicles to reduce carbon emissions and/or the costs associated with the charging operations. Thus, the energy usage information service 1102 can transmit the instances of the energy usage guidance 1104 to the entity 1106 via a first network occurrence 1110 (e.g., the Internet) and the entity 1106 can subsequently transmit the instances of the energy usage guidance 1104 to the customers 1108 via a second occurrence of a network 1112 (e.g., the Internet). The entity 1106 may add information to the energy usage guidance 1104 or perform other editing unrelated to the identified energy usage windows while the instances of the energy usage guidance 1104 are in the possession of the entity 1106.

The energy usage guidance 1104 can be based on prioritized forecasted events data 1114 that can be generated by the energy usage information service 1102 in the same manner described above relative to the energy usage information service 1002 of FIG. 10A. Likewise, the nature of the energy usage guidance 1104 transmitted to the entity 1106 may include the same or similar information provided by energy usage guidance 1104. The energy usage guidance 1104 may be presented in any of the ways and for any of the other effects described above relative to FIG. 10A. In some examples, each energy usage guidance 1104 instance may also include specialized information that is unique to a customer 1108, a customer vehicle, and/or may otherwise be specific to the process of charging the customer electric vehicle using electrical energy from the power grid.

The energy usage guidance 1104 may also consider the time-of-use (TOU) rate 1116 associated with the locations of a customer 1108, the customer vehicle, or the entity 1006. Use of the TOU rate 1116 can enable the energy usage information service 1102 to refine the energy usage guidance 1104 by identifying optimal electrical energy consumption windows that are based not only on renewable energy source generation but also on the cost of the electrical energy to the customers 1108 when using electrical energy from the power grid.

In an alternative embodiment to what is illustrated in FIGS. 10A-10B and FIG. 11, the energy usage information service 1102 can provide energy usage guidance directly to electrical energy consuming devices that are configured to act on the information in the energy usage guidance. For example, a “smart” EV charger may be communicatively coupled to the energy usage information service 1102 via a network (e.g., Internet) connection, and the EV charger may be configured to automatically adjust the charging schedule for an EV that is charged by the EV charger according to the energy usage guidance. Other electrical energy consuming devices such as, for example, phones, tablets, watches, battery-powered appliances, lights, etc., may also be capable of smart charging based on received energy usage guidance, whether through a native device configuration or through the addition of assistive applications, software upgrades, etc.

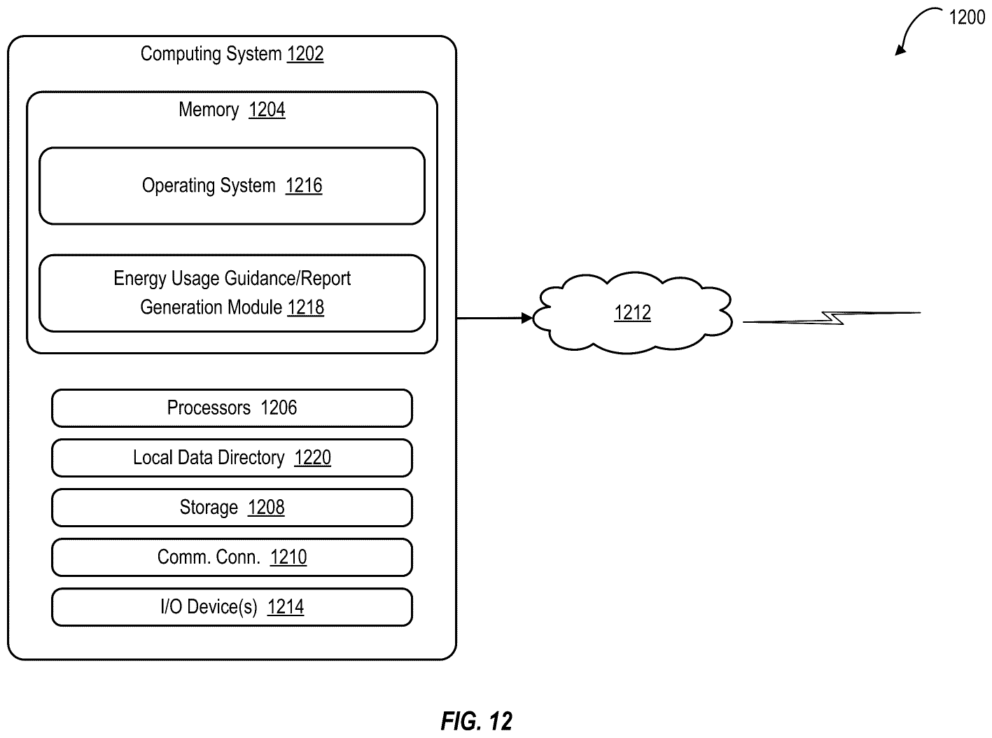

FIG. 12 illustrates an example architecture or environment 1200 configured to implement techniques relating to generating electrical energy usage guidance and shaping the load on a power grid around the availability of electrical energy supplied by renewable energy sources rather than nonrenewable energy sources. In one illustrative configuration, a computing system 1202 of an energy usage information service may include at least one memory 1204 and one or more processing units (or processor(s)) 1206. The processor(s) 1206 may be implemented in hardware, computer-executable instructions, firmware, or combinations thereof. Computer-executable instruction or firmware implementations of the processor(s) 1206 may include computer-executable or machine-executable instructions written in any suitable programming language to perform the various functions described.

The memory 1204 may store program instructions that are loadable and executable on the processor(s) 1206, as well as data generated during the execution of these programs. Depending on the configuration and type of the computing system 1202, the memory 1204 may be volatile (such as RAM) and/or non-volatile (such as ROM, flash memory, etc.). The computing system 1202 may also include additional removable storage and/or non-removable storage 1208 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 1204 may include multiple different types of memory, such as SRAM, DRAM, or ROM. While the volatile memory described herein may be referred to as RAM, any volatile memory that would not maintain data stored therein once unplugged from a host and/or power would be appropriate. The memory 1204 and the additional storage 1208, whether removable or non-removable, are both additional examples of non-transitory computer-readable storage media.

The computing system 1202 may also contain communications connection(s) 1210 that allow the computing system 1202 to communicate with a data store, another computing device or server, user terminals and/or other devices via one or more networks 1212. The computing system 1202 may also include I/O device(s) 1214, such as a keyboard, a mouse, a pen, a voice input device, a touch input device, a display, speakers, a printer, etc.

The memory 1204 may more specifically include an operating system 1216 and/or one or more application programs or services for implementing the features disclosed herein, including an energy usage guidance/report generation module 1218. The energy usage guidance/report generation module 1218 may be implemented in hardware, computer-executable instructions, firmware, or combinations thereof. In at least some embodiments, the computing system 1202 may include a local data directory 1220 that can serve as the local data directory referred to with respect to the operations of FIGS. 5-7.

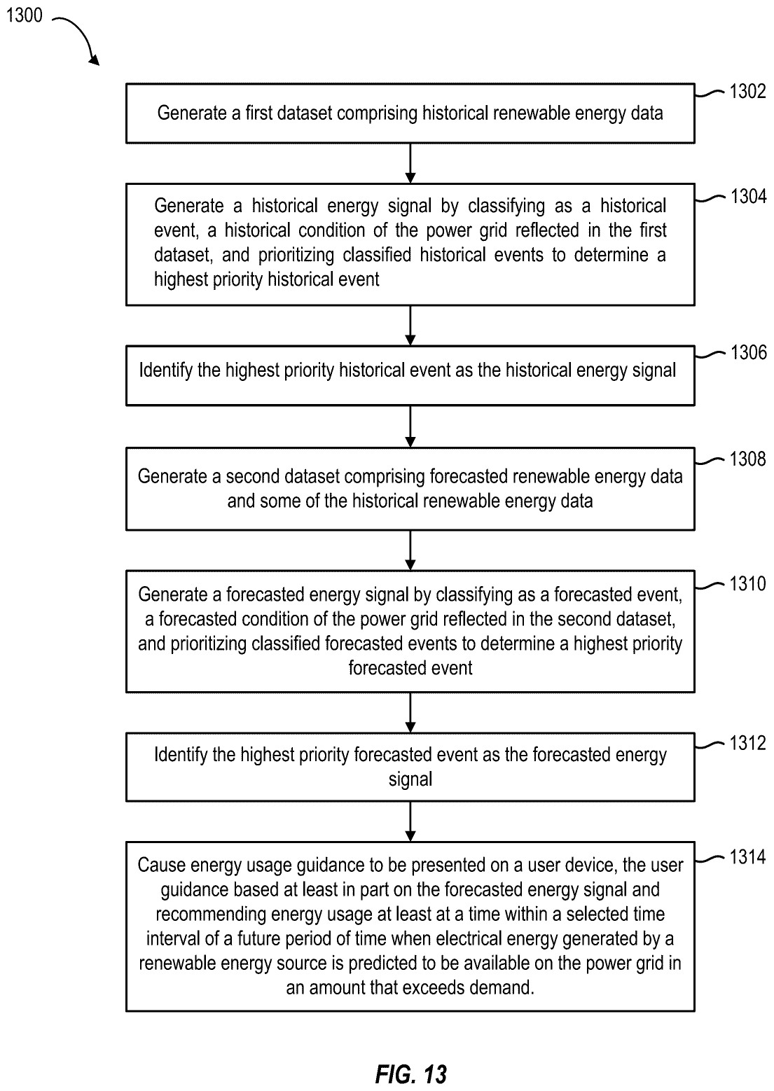

FIG. 13 is a process flow 1300 for a method of generating electrical energy usage guidance and shaping the load on a power grid according to one or more embodiments.

At 1302, the method can include generating, by a computing system, a first dataset comprising historical energy data recorded for a power grid over a first period of time. The historical energy data may comprise, for example, historical renewable energy generation data, historical renewable energy generation curtailment data, historical energy demand data, and historical marginal operating emissions rate (MOER) data. The data may be obtained from various sources, including energy providers, grid operators, government agencies, nonprofit organizations, etc. The historical data may cover operations of the power grid for a period of time. The data may be time series data that is recorded at regular intervals.

At 1304, the method can include generating, by the computing system, a historical energy signal that corresponds to a selected time interval of the first period of time. The historical energy signal can represent a ground truth. Generating the historical energy signal can include establishing goals and rules to guide the process.

Generating the historical energy signal can also include classifying (according to the goals and rules), as one or more historical events, one or more historical conditions of the power grid reflected in the first dataset and corresponding to the selected time interval of the first period of time. In some examples, the one or more historical events may comprise a historical period of renewable energy generation curtailment, a historical period of high renewable energy generation, a historical period of net peak demand, a historical period of low MOER, a historical period of high MOER, or a combination thereof. The renewable energy can be generated by, for example, a solar power plant or a wind power plant in some embodiments. High renewable energy generation may refer to renewable energy generation that occurs at an optimal time of day (e.g., during a period of maximum solar energy or wind velocity). Low MOER and high MOER may be defined by reference to other MOER values that occur within a given time period. Generating the historical energy signal can further include prioritizing the one or more classified historical events based on prioritization rules (of the goals and rules) to determine a highest priority historical event.

At 1306, the method can include identifying the highest priority historical event as the historical energy signal. In some examples, the historical energy signal can be used to generate an electrical energy usage report. An electrical energy usage report may advise a consumer whether selected prior usage on the part of the consumer was good or bad relative to supporting the use of renewable energy and/or from a rate standpoint.

At 1308, the method can include generating, by the computing system, a second dataset comprising forecasted energy data for the power grid relative to a future period of time and at least some of the historical energy data. The forecasted energy data may comprise forecasted renewable energy generation data and forecasted renewable energy curtailment data for the power grid during the future period of time, and at least some of the historical energy demand data and the historical MOER data. As with the first dataset, the data of the second dataset may be obtained from various sources.

At 1310, the method can include generating a forecasted energy signal that forecasts the historical energy signal and corresponds to a selected time interva 1 of the future period of time. The forecasted energy signal can represent a future opportunity to maximize the use of renewable energy.

Generating the forecasted energy signal can include classifying as one or more forecasted events (according to the goals and rules), one or more forecasted conditions of the power grid reflected in the second dataset and corresponding to the selected time interval of the future period of time. Unlike the historical periods period of renewable energy generation curtailment, historical period of high renewable energy generation, etc., the forecasted event represent a future time period. In some examples, the one or more forecasted events may comprise one or a combination of a forecasted period of renewable energy generation curtailment or a forecasted period of high renewable energy generation reflected in the second dataset and corresponding to the selected time interval of the future period of time, a forecasted period of net peak demand appearing in an output of a first machine model configured to receive the historical energy demand data as an input, and a forecasted period of low MOER or a forecasted period of high MOER appearing in an output of a second machine model configured to receive the at least some of the historical MOER data as an input. Generating the forecasted energy signal can further include prioritizing the one or more classified forecasted events based at least in part on the prioritization rules (of the goals and rules) to determine a highest priority forecasted event. Prioritizing the classified forecasted events can be accomplished in a like or similar manner to that used to prioritize the classified historical events.

Various types of machine-learning models may be used to generate portions of the forecasted signal. Some examples may include autoregressive integrated moving average (ARIMA) or seasonal autoregressive integrated moving average (SARIMA) models. A gradient boosting model such as XGBoost can also be used. The TiDE model and various transformer models may also be used for this purpose.

At 1312, the method can include identifying the highest priority forecasted event as the forecasted energy signal.

At 1314, the method can include causing, by the computing system, energy usage guidance to be presented on a user device. The energy usage guidance can be based at least in part on the forecasted energy signal and can recommend energy usage at least at a time within the selected time interval of the future period of time when electrical energy generated by a renewable energy source is predicted to be available on the power grid in an amount that exceeds demand

A user device may be a user computing device such as a smart phone or a smart watch in some examples. In some embodiments, energy usage guidance may be transmitted to a user as a message, or as a notification including but not limited to a push notification or an in-app notification that may appear as an in-line popup. In other examples, the user devices may execute an application which the energy usage guidance can be displayed.

Although specific embodiments have been described, it will be appreciated that embodiments may include all modifications and equivalents within the scope of the following claims. As described above, one aspect of the present technology is the gathering and use of data available from specific and legitimate sources to improve the delivery of messages from one device to one or more devices. The present disclosure contemplates that in some instances, this gathered data may include personal information data that uniquely identifies or may be used to identify a specific person. Such personal information data may include demographic data, location-based data, online identifiers, telephone numbers, email addresses, home addresses, date of birth, or any other personal information.

The present disclosure recognizes that the use of such personal information data, in the present technology, may be used to the benefit of users. For example, the personal information data may be used to deliver a command from a user profile on a computing device to one or more computing devices. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities may subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements may be provided to prevent or block access to such personal information data. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk may be minimized by limiting the collection of data and deleting data once it is no longer needed. In addition, and when applicable, including in certain health related applications, data de-identification may be used to protect a user's privacy. De-identification may be facilitated, when appropriate, by removing identifiers, controlling the amount or specificity of data stored (e.g., collecting streaming data without collecting account information), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments may also be implemented without the need for accessing such personal information data. That is, the various embodiments of the present technology are not rendered inoperable due to the lack of all or a portion of such personal information data. For example, content may be selected and delivered to users based on aggregated non-personal information data or a bare minimum amount of personal information, such as the content being handled only on the user's device or other non-personal information available to the content delivery services.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein may be implemented on the same processor or different processors in any combination. Accordingly, where components or modules are described as being configured to perform certain operations, such configuration may be accomplished, e.g., by designing electronic circuits to perform the operation, by programming programmable electronic circuits (such as microprocessors) to perform the operation, or any combination thereof. Processes may communicate using a variety of techniques, including but not limited to conventional techniques for inter-process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate embodiments, and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments may be utilized in any number of environments and applications beyond those described herein without departing from the broader spirit and scope of the specification. The specification and drawings are, accordingly, to be regarded as illustrative rather than restrictive.

What is claimed is:

1. A method, comprising:
generating, by a computing system, a first dataset comprising historical energy data recorded for a power grid over a first period of time;
generating, by the computing system, a historical energy signal that corresponds to a selected time interval of the first period of time by:
classifying as one or more historical events, one or more historical conditions of the power grid reflected in the first dataset and corresponding to the selected time interval of the first period of time,
prioritizing the one or more classified historical events based at least in part on prioritization rules to determine a highest priority historical event, and
identifying the highest priority historical event as the historical energy signal;
generating, by the computing system, a second dataset comprising forecasted energy data for the power grid relative to a future period of time and at least some of the historical energy data;
generating, by the computing system, a forecasted energy signal that forecasts the historical energy signal and corresponds to a selected time interval of the future period of time by:
classifying as one or more forecasted events, one or more forecasted conditions of the power grid reflected in the second dataset and corresponding to the selected time interval of the future period of time,
prioritizing the one or more classified forecasted events based at least in part on the prioritization rules to determine a highest priority forecasted event, and
identifying the highest priority forecasted event as the forecasted energy signal; and
causing, by the computing system, energy usage guidance to be presented on a user device, the energy usage guidance based at least in part on the forecasted energy signal and recommending energy usage at least at a time within the selected time interval of the future period of time when electrical energy generated by a renewable energy source is predicted to be available on the power grid in an amount that exceeds demand.

2. The method of claim 1, wherein:
the historical energy data comprises historical renewable energy generation data, historical renewable energy generation curtailment data, historical energy demand data, and historical marginal operating emissions rate (MOER) data;
the one or more historical events comprise a historical period of renewable energy generation curtailment, a historical period of high renewable energy generation, a historical period of net peak demand, a historical period of low MOER, a historical period of high MOER, or a combination thereof;
the forecasted energy data comprises forecasted renewable energy generation data and forecasted renewable energy curtailment data for the power grid during the future period of time, and at least some of the historical energy demand data and the historical MOER data; and
the one or more forecasted events comprise one or a combination of:
a forecasted period of renewable energy generation curtailment or a forecasted period of high renewable energy generation reflected in the second dataset and corresponding to the selected time interval of the future period of time;
a forecasted period of net peak demand appearing in an output of a first machine model configured to receive the historical energy demand data as an input; and
a forecasted period of low MOER or a forecasted period of high MOER appearing in an output of a second machine model configured to receive the at least some of the historical MOER data as an input.

3. The method of claim 1, wherein the historical energy signal is a ground truth.

4. The method of claim 1, wherein high renewable energy generation is renewable energy generation having an output value greater than a threshold of all other renewable energy generation supplied to the power grid during a given day.

5. The method of claim 1, wherein:
the first dataset further includes historical grid alert data, and a historical grid alert condition corresponding to the selected time interval of the first period of time is classified as a grid alert historical event; and
the grid alert historical event is prioritized with other historical events of the first dataset.

6. The method of claim 1, further comprising causing, by the computing system, an energy report to be presented on the user device, the energy report based at least in part on the historic energy signal and indicating what portion of energy consumed by the user during a defined past time period was satisfied by a renewable energy source.

7. The method of claim 1, wherein the energy usage guidance is further based at least in part on a predicted time-of-use rate for the future time interval.

8. A computing system, comprising:
one or more processors; and
one or more computer-readable media having stored thereon a sequence of instructions that, when executed by the one or more processors, causes the one or more processors to perform operations comprising:
generating a first dataset comprising historical energy data recorded for a power grid over a first period of time;
generating a historical energy signal that corresponds to a selected time interval of the first period of time by:
classifying as one or more historical events, one or more historical conditions of the power grid reflected in the first dataset and corresponding to the selected time interval of the first period of time,
prioritizing the one or more classified historical events based at least in part on prioritization rules to determine a highest priority historical event, and
identifying the highest priority historical event as the historical energy signal;
generating a second dataset comprising forecasted energy data for the power grid relative to a future period of time and at least some of the historical energy data;
generating a forecasted energy signal that forecasts the historical energy signal and corresponds to a selected time interval of the future period of time by:
classifying as one or more forecasted events, one or more forecasted conditions of the power grid reflected in the second dataset and corresponding to the selected time interval of the future period of time,
prioritizing the one or more classified forecasted events based at least in part on the prioritization rules to determine a highest priority forecasted event, and
identifying the highest priority forecasted event as the forecasted energy signal; and
causing energy usage guidance to be presented on a user device, the energy usage guidance based at least in part on the forecasted energy signal and recommending energy usage at least at a time within the selected time interval of the future period of time when electrical energy generated by a renewable energy source is predicted to be available on the power grid in an amount that exceeds demand.

9. The computing system of claim 8, wherein:
the historical energy data comprises historical renewable energy generation data, historical renewable energy generation curtailment data, historical energy demand data, and historical marginal operating emissions rate (MOER) data;
the one or more historical events comprise a historical period of renewable energy generation curtailment, a historical period of high renewable energy generation, a historical period of net peak demand, a historical period of low MOER, a historical period of high MOER, or a combination thereof;
the forecasted energy data comprises forecasted renewable energy generation data and forecasted renewable energy curtailment data for the power grid during the future period of time, and at least some of the historical energy demand data and the historical MOER data; and
the one or more forecasted events comprise one or a combination of:
a forecasted period of renewable energy generation curtailment or a forecasted period of high renewable energy generation reflected in the second dataset and corresponding to the selected time interval of the future period of time;
a forecasted period of net peak demand appearing in an output of a first machine model configured to receive the historical energy demand data as an input; and
a forecasted period of low MOER or a forecasted period of high MOER appearing in an output of a second machine model configured to receive the at least some of the historical MOER data as an input.

10. The computing system of claim 8, wherein the historical energy signal is a ground truth.

11. The computing system of claim 8, wherein high renewable energy generation is renewable energy generation having an output value greater than a threshold of all other renewable energy generation supplied to the power grid during a given day.

12. The computing system of claim 8, wherein the first dataset further includes historical grid alert data, and the operations further comprise:
classifying a historical grid alert condition corresponding to the selected time interval of the first period of time as a grid alert historical event; and
prioritizing the grid alert historical event with other historical events of the first dataset.

13. The computing system of claim 8, wherein the operations further comprise causing an energy report to be presented on the user device, the energy report based at least in part on the historic energy signal and indicating what portion of energy consumed by the user during a defined past time period was satisfied by a renewable energy source.

14. The computing system of claim 8, wherein the energy usage guidance is further based at least in part on a predicted time-of-use rate for the future time interval.

15. One or more non-transitory computer-readable media having stored thereon a sequence of instructions that, when executed by one or more processors of a first computing device, cause the one or more processors to perform operations comprising:
generating, by a computing system, a first dataset comprising historical energy data recorded for a power grid over a first period of time;
generating, by the computing system, a historical energy signal that corresponds to a selected time interval of the first period of time by:
classifying as one or more historical events, one or more historical conditions of the power grid reflected in the first dataset and corresponding to the selected time interval of the first period of time,
prioritizing the one or more classified historical events based at least in part on prioritization rules to determine a highest priority historical event, and
identifying the highest priority historical event as the historical energy signal;
generating, by the computing system, a second dataset comprising forecasted energy data for the power grid relative to a future period of time and at least some of the historical energy data;
generating, by the computing system, a forecasted energy signal that forecasts the historical energy signal and corresponds to a selected time interval of the future period of time by:
classifying as one or more forecasted events, one or more forecasted conditions of the power grid reflected in the second dataset and corresponding to the selected time interval of the future period of time,
prioritizing the one or more classified forecasted events based at least in part on the prioritization rules to determine a highest priority forecasted event, and
identifying the highest priority forecasted event as the forecasted energy signal; and
causing, by the computing system, energy usage guidance to be presented on a user device, the energy usage guidance based at least in part on the forecasted energy signal and recommending energy usage at least at a time within the selected time interval of the future period of time when electrical energy generated by a renewable energy source is predicted to be available on the power grid in an amount that exceeds demand.

16. The non-transitory computer-readable media of claim 15, wherein:
the historical energy data comprises historical renewable energy generation data, historical renewable energy generation curtailment data, historical energy demand data, and historical marginal operating emissions rate (MOER) data;
the one or more historical events comprise a historical period of renewable energy generation curtailment, a historical period of high renewable energy generation, a historical period of net peak demand, a historical period of low MOER, a historical period of high MOER, or a combination thereof;
the forecasted energy data comprises forecasted renewable energy generation data and forecasted renewable energy curtailment data for the power grid during the future period of time, and at least some of the historical energy demand data and the historical MOER data; and
the one or more forecasted events comprise one or a combination of:
a forecasted period of renewable energy generation curtailment or a forecasted period of high renewable energy generation reflected in the second dataset and corresponding to the selected time interval of the future period of time;
a forecasted period of net peak demand appearing in an output of a first machine model configured to receive the historical energy demand data as an input; and
a forecasted period of low MOER or a forecasted period of high MOER appearing in an output of a second machine model configured to receive the at least some of the historical MOER data as an input.

17. The non-transitory computer-readable media of claim 15, wherein high renewable energy generation is renewable energy generation having an output value greater than a threshold of all other renewable energy generation supplied to the power grid during a given day.

18. The non-transitory computer-readable media of claim 15, wherein the first dataset further includes historical grid alert data, and the operations further comprise:
classifying a historical grid alert condition corresponding to the selected time interval of the first period of time as a grid alert historical event; and
prioritizing the grid alert historical event with other historical events of the first dataset.

19. The non-transitory computer-readable media of claim 15, wherein the operations further comprise causing an energy report to be presented on the user device, the energy report based at least in part on the historic energy signal and indicating what portion of energy consumed by the user during a defined past time period was satisfied by a renewable energy source.

20. The non-transitory computer-readable media of claim 15, wherein the energy usage guidance is further based at least in part on a predicted time-of-use rate for the future time interval.
